(19) United States
(12) Patent Application Publication
(10) Pub. No.: US 2026/0289709 A1
(43) Pub. Date: Sep. 24, 2026

(54) SYSTEM

(71) Applicant: SoftBank Group Corp., Tokyo (JP)

(72) Inventor: Yushi YAMADA, Tokyo (JP)

(73) Assignee: SoftBank Group Corp., Tokyo (JP)

(21) Appl. No.: 19/563,281

(22) Filed: Mar. 11, 2026

(30) Foreign Application Priority Data
Mar. 19, 2025 (JP) 2025-045003

(51) Int. Cl. G06Q 50/20; G06N 3/0475

(52) U.S. Cl. CPC G06Q 50/20; G06N 3/0475

(57) ABSTRACT

A system includes a processor that is configured to acquire learning history data and behavior pattern data of a learner from a database and analyze the acquired data by using a machine learning algorithm, input a prompt to a generative artificial intelligence model so as to instruct the generative artificial intelligence model to generate optimal educational content based on an analysis result obtained by the machine learning algorithm, and monitor, in real time, a comprehension level and a learning progress of the learner and dynamically update an educational plan as needed.

### CROSS-REFERENCE TO RELATED APPLICATION

This application is based on and claims priority under 35 USC 119 from Japanese Patent Application No. 2025-045003 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional computer-aided learning systems and AI tutoring systems typically present static or semi-static learning content that is only loosely tailored to a learner's abilities. Even when user behavior such as question response times or correctness is collected, such systems often fail to fully utilize this data in real time to generate optimally personalized educational content. In particular, there is insufficient integration between: (i) data-driven analysis of learning history and behavior patterns using machine learning algorithms, and (ii) prompt-based control of generative artificial intelligence models that are capable of flexibly creating or adapting educational content.

Moreover, many existing systems inadequately account for the learner's emotional state, such as confusion, frustration, boredom, or engagement, when determining what content to present next or how to present it. Emotional states can significantly affect learning efficiency and motivation, but known systems typically do not recognize emotions from multimodal input such as facial expressions, voice characteristics, and free-text responses, nor do they systematically use such emotional information to adjust an educational plan in real time.

As a result, there is a need for a system that can (a) acquire and analyze detailed learning history and behavior patterns for each learner using machine learning algorithms, (b) generate prompts that instruct a generative AI model to create optimal educational content based on the analysis results, (c) monitor the learner's comprehension level and progress in real time and dynamically update an educational plan, and (d) recognize the learner's emotional state using a combination of sensors and emotion analysis algorithms and reflect the recognized emotional state in dynamic updates to the educational plan. Without such an integrated system, it is difficult to continuously maintain both cognitive suitability and emotional responsiveness of the educational content for each individual learner.

### SUMMARY

In order to solve the above-described problems, according to one aspect of the present invention, there is provided a system comprising a processor, wherein the processor is configured to acquire learning history data and behavior pattern data of a learner from a database and analyze the acquired data by using a machine learning algorithm. By performing this analysis, the processor can estimate, for example, the learner's knowledge state, typical error patterns, pace of learning, and preferred interaction styles.

The processor is further configured to input a prompt to a generative artificial intelligence model so as to instruct the generative artificial intelligence model to generate optimal educational content based on an analysis result obtained by the machine learning algorithm.

The prompt may specify, for example, target concepts, expected difficulty levels, preferred explanation style, or recommended types of exercises. In this way, the generative AI model can dynamically produce explanations, examples, questions, and feedback that are tailored to the learner's current state as inferred from the analysis results.

In addition, the processor is configured to monitor, in real time, a comprehension level and a learning progress of the learner and to dynamically update an educational plan as needed. The processor may, for instance, continuously evaluate the learner's correctness rates, response times, and interaction patterns during learning sessions, and, when certain conditions are met, revise the sequence of topics, the depth of coverage, or the amount and type of practice included in the educational plan.

In another aspect, the processor is configured to use a combination of a plurality of sensors and an emotion analysis algorithm to recognize an emotional state of the learner from at least one of a facial expression, a voice, and a text input of the learner. For example, the system may utilize a camera to capture facial expressions, a microphone to capture vocal features, and a user interface to capture typed comments or answers, and the emotion analysis algorithm may classify the learner's emotional state as confusion, frustration, boredom, satisfaction, or engagement.

Furthermore, the processor is configured to dynamically update the educational plan by inputting, in accordance with an emotional state of the learner, a new prompt to the generative artificial intelligence model so as to instruct the generative artificial intelligence model to update the educational plan that has been generated. When the learner's emotional state indicates difficulty or frustration, the processor can prompt the generative AI model to simplify explanations, provide additional step-by-step guidance, or insert remedial content. When the emotional state indicates boredom or that the content is too easy, the processor can prompt the generative AI model to increase difficulty, add more challenging problems, or diversify the learning activities. By combining real-time cognitive monitoring with emotion recognition and prompt-based control of a generative AI model, the system can maintain an educational plan that is continuously adapted to both the learner's comprehension level and emotional state.

The term “processor” refers to one or more hardware processing units, such as a central processing unit (CPU), a graphics processing unit (GPU), or a specialized accelerator, and may further encompass a combination of such units that execute computer-readable instructions to perform the functions described herein.

The term “learning history data” refers to data representing past learning activities of a learner, including but not limited to records of studied topics, accessed materials, answered questions, correctness of answers, timestamps of interactions, durations of study sessions, and other logs indicative of the learner's prior learning behavior.

The term “behavior pattern data” refers to data characterizing how a learner interacts with learning content over time, including, for example, response times, frequency of hint requests, skipping behavior, navigation paths, repetition of certain materials, and any statistically observable patterns in the learner's study actions.

The term “database” refers to any structured data storage system, including relational databases, key-value stores, document databases, or other persistent storage mechanisms, that is configured to store and provide access to learning history data, behavior pattern data, or other information used by the system.

The term “machine learning algorithm” refers to a computational method or model, such as a neural network, decision tree, support vector machine, probabilistic model, or ensemble thereof, that is trained on data and configured to perform tasks including, but not limited to, classification, regression, clustering, pattern recognition, or prediction relating to a learner's state or behavior.

The term “analysis result” refers to information derived from applying a machine learning algorithm to learning history data and behavior pattern data, such as estimated knowledge levels, predicted difficulties, learning pace, preferred content style, or other inferred characteristics of the learner.

The term “generative artificial intelligence model” refers to a computational model that is configured to generate content in response to input information, including, for example, large language models, generative adversarial networks, or other generative models capable of producing text, questions, explanations, or other educational content.

The term “prompt” refers to a structured or unstructured input supplied to a generative artificial intelligence model, the input including instructions, constraints, context, or parameters that specify, at least in part, the type, style, difficulty, or scope of educational content to be generated by the generative artificial intelligence model.

The term “optimal educational content” refers to educational material that is selected or generated so as to be appropriate for a learner's current knowledge state, learning objectives, and preferences, and may include explanations, examples, exercises, feedback, or other instructional elements designed to enhance learning effectiveness.

The term “comprehension level” refers to a measure or estimate of how well a learner understands a particular concept, topic, or skill, the measure being determined, for example, from correctness of responses, consistency of performance, or other indicators of understanding.

The term “learning progress” refers to a measure or estimate of the advancement of a learner through one or more educational objectives, topics, or curricula, including indicators such as completed units, mastery of concepts, pace of completion, and changes in performance over time.

The term “real time” refers to operation in which processing and responses occur with a latency that is sufficiently low such that the system can update educational content or plans during an ongoing learning session without perceptible delay that would disrupt the learner's interaction.

The term “educational plan” refers to a structured arrangement or schedule of learning activities, topics, materials, and assessments for a learner, including, for example, the order of topics, the allocation of time, and the selection of specific content items to be studied.

The term “dynamically update” refers to modifying an educational plan or content during operation based on newly acquired data, such as recent learner performance or emotional state, without requiring manual redesign or reinitialization of the overall system.

The term “sensor” refers to any device or component configured to capture physical or digital signals related to a learner, including, for example, cameras, microphones, biometric sensors, or input interfaces that provide information such as facial images, voice recordings, or text inputs.

The term “emotion analysis algorithm” refers to a computational method or model configured to infer or classify an emotional state of a learner based on input data including, but not limited to, facial expressions, voice characteristics, linguistic features of text, physiological signals, or combinations thereof.

The term “emotional state” refers to a psychological condition of a learner, such as confusion, frustration, boredom, engagement, satisfaction, or motivation, as inferred or classified by an emotion analysis algorithm based on sensor data or user inputs.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

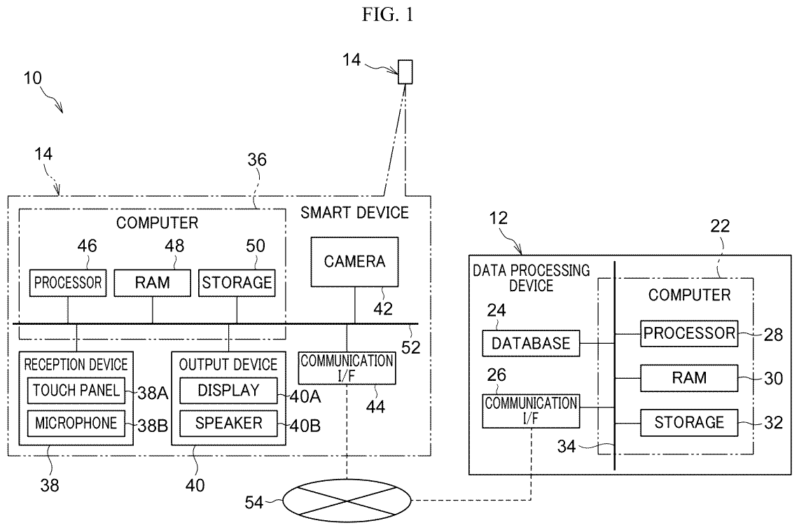

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

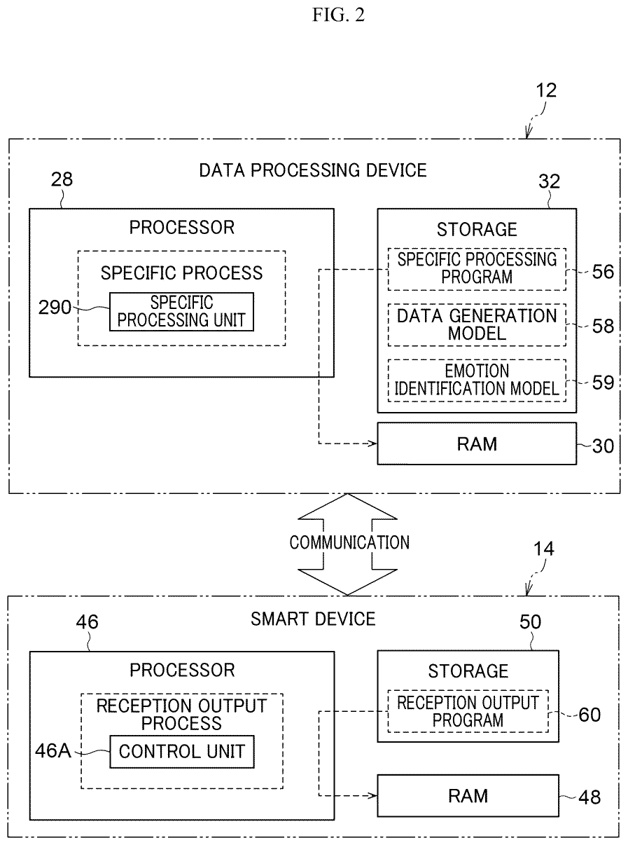

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented tutoring systems typically rely on fixed rules or static recommendation logic to determine what educational content to show next to a learner. In such systems, a processor often selects subsequent tasks based solely on simple metrics, such as a most recent test score or completion status flags, and transmits predetermined content from a storage device to a user terminal. As a result, the underlying computer system merely retrieves and displays content without performing deeper, context-aware processing of continuously accumulated learning history, behavior tendencies, and emotional states. This lack of rich, integrated processing leads to several technical problems.

First, conventional systems do not maintain or utilize a unified, machine-readable representation of learning history information and behavior tendency information across multiple sessions and devices. Learning activity logs, answer times, correctness rates, hint requests, and interaction patterns may be stored in disparate formats or locations, and a processor does not efficiently aggregate these data into performance indices suitable for dynamic, fine-grained adaptation. Consequently, the system's data structures and algorithms are not optimized for iterative, session-by-session reconfiguration of education plans.

Second, even when a generative AI model is introduced, it is often invoked in an ad hoc manner, for example, by sending unstructured or loosely structured queries that do not fully encode the learner's performance indices, constraints, and emotional states. The processor typically forwards free-form text without a consistent prompt design, and the generative AI model returns text that is not aligned with the internal data structures of the tutoring system. This misalignment makes it difficult for the computer system to automatically parse and reuse the model output for machine-controlled scheduling, selection of problem items, and persistent storage of education plan data. As a result, the generative AI model behaves as an isolated component, and the overall system cannot reliably or efficiently update educational content in real time.

Third, conventional architectures rarely integrate emotion state information—derived from sensors such as cameras, microphones, or text interfaces—into the core computation path that drives plan generation and update. Emotion-related signals, if used at all, are often processed separately from learning history metrics. This separation prevents the processor from adaptively modifying the prompt provided to the generative AI model or reconfiguring the education plan data when the learner shows signs of frustration, fatigue, or boredom.

Accordingly, the system fails to utilize available sensor and processing resources to stabilize or improve the quality of interaction and the effectiveness of learning guidance.

Fourth, existing systems generally do not implement a closed computational loop in which newly obtained learning history information and emotion state information continually drive recalculation of performance indices, dynamic update of prompt sentences, and sequential regeneration of machine-readable education plan data. Without such a loop, the processor cannot continuously adapt the internal data structures and external behavior of the system over time. This leads to inefficient use of storage and processing resources, delayed responsiveness to learner state changes, and limited ability to personalize content at the level of session-by-session granularity.

Therefore, there is a need for a computer-implemented system and method in which a processor (i) aggregates and manages learning history information and behavior tendency information as structured data, (ii) computes performance indices and evaluation results, (iii) generates and dynamically updates prompt sentences that encode these indices and constraints, (iv) cooperates with a generative AI model to obtain individualized education plan candidates, (v) converts these candidates into machine-readable education plan data suitable for efficient storage, retrieval, and execution, and (vi) integrates emotion state information into the same computational loop. Such a system should improve the functioning of the computer by enabling the processor to automatically and adaptively reconfigure internal data representations and control flows for educational content delivery, rather than performing only static content retrieval.

The specific processing by the specific processing unit 290 of the data processing device 12 in Example 1 is realized by the following means.

The present invention provides a server comprising a processor and a storage device, the processor being configured to: acquire, from a plurality of information processing terminals, learning activity information and behavior tendency information for each learner; manage the acquired learning activity information and behavior tendency information in the storage device as integrated learning history information; compute performance indices including at least a learning field, a learning subject, an answer history, an answer time, a correctness rate, a learning time, and a support request frequency based on the learning history information; evaluate a comprehension level, a learning progress, and a learning characteristic of the learner by executing statistical processing and machine learning processing using the performance indices; generate, based on an evaluation result and the performance indices, a prompt sentence in a natural language that describes creation conditions and constraint conditions of an education plan; input the prompt sentence to a generative artificial intelligence model and obtain, from the generative artificial intelligence model, an individualized education plan candidate including at least a time allocation, a learning activity type, and a question configuration; analyze the education plan candidate, convert the education plan candidate into education plan data in a machine-readable format including elements of a learning unit, a learning procedure, a learning time, and a problem identifier; store the education plan data in the storage device and transmit the education plan data to the information processing terminals; present learning tasks to the learner via the information processing terminals based on the education plan data and acquire, via the information processing terminals, response information including at least an answer content, an answer time, an operation history, and a support request history with respect to the learning tasks, thereby generating new learning history information and additionally storing the new learning history information in the storage device; recalculate the performance indices and the evaluation result based on updated learning history information including the new learning history information; dynamically update the prompt sentence to be input to the generative artificial intelligence model according to a recalculation result; and sequentially update the individualized education plan candidate obtained from the generative artificial intelligence model so as to adaptively change the education plan for each learner over time.

This enables improvement of the functioning of the computer-implemented tutoring system by establishing a closed computational loop in which structured learning history information and emotion-aware performance indices are repeatedly transformed, via dynamically updated prompt sentences and interaction with the generative artificial intelligence model, into machine-readable education plan data that are automatically reconfigured and executed by the server and the information processing terminals, thereby providing more efficient data management, more responsive generation and update of educational content, and more adaptive control of learning guidance compared to conventional static or rule-based systems.

The term “learning activity information” refers to information indicating actions performed by a learner in connection with educational content, including at least selection of subjects or topics, viewing of learning materials, answering of problems, and progress through learning tasks.

The term “behavior tendency information” refers to information indicating patterns of a learner's interaction with an educational system over time, including at least frequencies of hint requests, problem skipping, revisiting of materials, and other repeated operation behaviors.

The term “information processing terminal” refers to an electronic apparatus having at least an input device, an output device, a communication interface, and a processor, and configured to communicate with a server to present educational content and to capture learner interaction data.

The term “storage device” refers to a non-transitory computer-readable recording medium configured to store data including learning history information, education plan data, and configuration information of a system.

The term “learning history information” refers to integrated data obtained by accumulating and managing learning activity information and behavior tendency information for a learner across a plurality of sessions, including at least answer logs, timestamps, correctness information, and usage history of support functions.

The term “performance indices” refers to quantitative or qualitative indicators computed from learning history information, including at least indices relating to a learning field, a learning subject, an answer history, an answer time, a correctness rate, a learning time, and a support request frequency.

The term “learning field” refers to a broad classification category of subject matter to be studied by a learner, such as mathematics, language, or science, as represented in the system in a generalized form.

The term “learning subject” refers to a finer-grained classification within a learning field, indicating a specific topic or unit of study, such as a type of equation or a grammar category, as represented in the system in an abstracted form.

The term “answer history” refers to a record of responses provided by a learner to presented problems or questions, including at least answer contents, associated problem identifiers, and result information of correctness or incorrectness.

The term “answer time” refers to a time duration measured between a start of presentation of a problem to a learner and a completion of an answer input by the learner.

The term “correctness rate” refers to an index indicating a ratio of correctly answered problems to a total number of attempted problems over a specified subset of learning history information.

The term “learning time” refers to an amount of time during which a learner is engaged in learning activities recognized by the system, including at least durations of content viewing and problem solving.

The term “support request frequency” refers to an index indicating how often a learner invokes support-related functions, including at least hint display, explanation request, or assistance calls, in relation to presented learning tasks.

The term “comprehension level” refers to an evaluation result representing a degree to which a learner is estimated to understand educational content, derived from performance indices using statistical processing or machine learning processing.

The term “learning progress” refers to an evaluation result representing a degree to which a learner has advanced through an intended curriculum or set of learning subjects, based on accumulated learning history information.

The term “learning characteristic” refers to an evaluation result representing distinctive tendencies of a learner's learning behavior, including at least response speed, persistence, support dependency, and preferred activity types.

The term “statistical processing” refers to computation performed by a processor using statistical methods, such as aggregation, averaging, variance calculation, or trend detection, on learning history information to derive performance indices.

The term “machine learning processing” refers to computation performed by a processor using a machine learning model, such as a classifier, a regressor, or a clustering model, to infer evaluation results including comprehension level and learning characteristics from performance indices.

The term “prompt sentence” refers to a text sequence expressed in a natural language and including at least creation conditions and constraint conditions of an education plan, indices relating to learner performance, and instructions to a generative artificial intelligence model.

The term “generative artificial intelligence model” refers to a computational model trained to generate output content, such as text or structured data, in response to an input including a prompt sentence, by predicting subsequent tokens or structures based on learned patterns.

The term “education plan” refers to an arrangement of learning activities to be provided to a learner over a defined period, including at least a sequence of learning units, time allocations, activity types, and problem sets.

The term “education plan candidate” refers to a draft or proposed form of an education plan generated by a generative artificial intelligence model in response to a prompt sentence, prior to conversion into an internal machine-readable data structure.

The term “time allocation” refers to an assignment of approximate durations to respective learning units or activities within an education plan.

The term “learning activity type” refers to a classification of a learning step in an education plan, including at least review activities, practice activities, and evaluation activities.

The term “question configuration” refers to a specification of characteristics of problems or questions to be presented, including at least a number of problems, difficulty levels, topics, and ordering.

The term “learning unit” refers to a smallest or fundamental segment of a learning process in an education plan, such as a single explanation block, a problem set, or a quiz, identified by the system as an execution unit.

The term “learning procedure” refers to an ordered sequence or control flow of learning units to be presented to a learner according to an education plan.

The term “problem identifier” refers to an identifier associated with a particular problem item stored in a problem database, enabling the system to retrieve and present the corresponding content.

The term “education plan data” refers to a machine-readable data structure representing the content of an education plan, including at least learning units, learning procedures, learning times, and problem identifiers.

The term “response information” refers to information acquired from an information processing terminal indicating how a learner responded to learning tasks, including at least answer contents, answer times, operation histories, and support request histories.

The term “operation history” refers to information indicating sequences of user interface operations performed by a learner, such as button presses, navigation actions, and hint requests, during execution of learning tasks.

The term “support request history” refers to a record of events in which a learner requested assistance from the system, including at least times and types of requested support.

The term “updated learning history information” refers to learning history information that has been augmented with new learning history information generated from additional learning sessions.

The term “emotion state information” refers to information indicating an estimated emotional condition of a learner, such as frustration, engagement, or fatigue, derived from one or more sensor inputs.

The term “expression information” refers to information relating to facial features or expressions of a learner captured by an image capture device and processed to infer emotional states.

The term “voice information” refers to information relating to acoustic signals emitted by a learner, captured by an audio input device and processed to infer emotional states or other parameters.

The term “character information” refers to text-based input information provided by a learner, such as typed or selected text, processed to infer emotional states or attitudes.

The term “sensor device” refers to an apparatus configured to acquire physical signals, including at least image, audio, or physiological signals, for use in estimating a learner's state.

The term “input/output device” refers to a device that enables data input from and data output to a learner, including at least a display, a keyboard, a pointing device, a touchscreen, a microphone, or a speaker.

The term “emotion analysis processing” refers to processing in which a processor analyzes sensor data or interaction data to infer an emotion state of a learner, using at least pattern recognition, statistical methods, or machine learning methods.

The term “support presentation policy” refers to a rule set or parameterization that determines how and when the system presents support to a learner, including at least hint provision frequency, granularity of explanations, and timing of feedback.

The term “allocation ratio” refers to a proportion of total learning time or total education plan steps assigned to different learning activity types, such as review, practice, and evaluation.

The term “question order” refers to an arrangement in which multiple problems or questions are sequenced for presentation to a learner within an education plan.

The term “support presentation frequency” refers to an index or control parameter indicating how often support information, such as hints or explanations, is presented to a learner during execution of an education plan.

The term “adaptively change” refers to the act of a system automatically modifying parameters or structures of an education plan based on updated learning history information, performance indices, and emotion state information, without requiring manual redesign of the plan for each learner.

In an embodiment, a server cooperates with multiple terminals to provide individualized education plans to users who are learners. The server implements the claimed functions using specific hardware and software components, and processes structured data in a manner that improves the operation of the computer system itself, including data management efficiency, processing speed, and adaptability of plan generation.

The server uses computing hardware such as a rack-mounted computer or a cloud-based virtual machine equipped with a multi-core central processing unit, a main memory, a non-transitory storage device, and a network interface. For example, the server uses a general-purpose processor of an x86 or ARM architecture, main memory such as DRAM, a storage device such as a solid-state drive, and a network interface compatible with Ethernet. The server runs an operating system such as a UNIX-like system and executes application software implemented, for example, in a high-level programming language with a web framework. The server uses a relational database management system such as a relational database engine to store and retrieve learning history information and education plan data.

The server also uses an application programming interface client library to access a generative AI model hosted either locally or on a separate computing resource.

The terminal uses hardware such as a smartphone, a tablet, or a personal computer including at least a processor, a memory, a display device, an input device, and a wireless or wired network interface. The terminal runs a client application implemented using a platform-specific development kit, such as a mobile operating system development framework. The terminal displays educational content, captures user interactions, and transmits learning activity information and behavior tendency information to the server over a network using a communication protocol such as HTTPS.

The user operates the terminal during learning sessions. The user selects subjects and topics, views explanations, solves problems, requests hints, and sends free-text queries. The terminal records these operations as structured data and sends the data to the server, thereby populating and updating learning history information.

The server stores learning history information in the relational database using normalized tables. The server uses, for example, a “Learner” table, a “Session” table, a “Problem” table, an “AnswerLog” table, and a “PlanStep” table. The “AnswerLog” table includes fields such as learner identifier, session identifier, problem identifier, timestamp, answer content, correctness flag, response time, hint usage flag, and navigation operations. The server manages behavior tendency information, such as support request frequency and skipping patterns, by aggregating fields in the “AnswerLog” and related tables. The server uses indexes on learner identifier, topic identifier, and timestamp fields to improve query performance when computing performance indices.

The server computes performance indices by executing SQL queries combined with application-level statistical processing. For example, the server calculates correctness rate per topic by counting correct answers and total attempts, and computes answer time distributions by summing and averaging response time fields. The server also computes support request frequency by counting hint usage flags, and computes learning time by accumulating time differences between session start and end events. The server maps topics and problem identifiers to higher-level learning fields and learning subjects using a taxonomy stored in the “Problem” and “Subject” tables.

The server evaluates comprehension level, learning progress, and learning characteristics using a machine learning model executed on the server. In one embodiment, the server uses a gradient boosting model or a feedforward neural network as a performance evaluation model.

The server extracts feature vectors for each learner that include aggregated indices such as topic-wise correctness rates, recent trends of accuracy (e.g., slope over the last N sessions), percentiles of response times, distributions of difficulty levels answered correctly, and counts of hint usage per unit time. The server normalizes these features and feeds them into the performance evaluation model to predict a comprehension score and a progress score for each learning subject.

The server uses a loss function such as mean squared error or cross-entropy during an offline training phase of the performance evaluation model, and updates model weights using an optimization method such as stochastic gradient descent or a variant. The server optionally retrains or fine-tunes the model using new anonymized learning history data periodically. By doing so, the server adapts its evaluation functions to empirical learner behavior, improving prediction accuracy and enabling more precise education plan generation.

The server constructs a prompt sentence for a generative AI model by encoding the computed performance indices and evaluation results into natural language with a constrained structure.

The server uses an internal template that specifies sections such as learner overview, performance statistics, desired plan length, activity types, and constraints. The server populates the template with values obtained from the performance indices and evaluation results, and generates a coherent prompt sentence string.

For example, the server generates a prompt sentence such as:

“You are an AI tutor. Analyze the following learner history for Student A in the subject of mathematics, focusing on the topic ‘quadratic equations’. The learner's overall correctness rate on this topic is 58%, and the average answer time is 80 seconds per problem. The learner has attempted 25 problems in the last week, frequently requested hints, and showed particular difficulty with tasks that require completing the square without step-by-step guidance. Create a 40-minute personalized study plan including: (1) short conceptual review steps, (2) a sequence of practice problems with gradually increasing difficulty, and (3) a short quiz at the end to confirm understanding. Provide the output as a numbered list of steps, each with an estimated time in minutes and a brief description of the activity.”

The server transmits the prompt sentence to the generative AI model. In one embodiment, the generative AI model is a transformer-based neural network implemented with a multi-layer self-attention architecture. The generative AI model uses a token embedding layer, multiple attention blocks with multi-head attention, feedforward sublayers, normalization layers, and an output softmax layer. The generative AI model predicts output tokens conditioned on the prompt sentence. The generative AI model is pre-trained on large text corpora using an autoregressive language modeling objective, and optionally fine-tuned on domain-specific educational dialogues or plan generation examples. The generative AI model uses a loss function such as cross-entropy between predicted and target tokens during its training phase, and updates weights using an optimization algorithm such as Adam or an equivalent.

The server configures parameters of the generative AI model invocation, such as maximum output length, sampling temperature, and top-k or top-p sampling thresholds, to control the style and variability of the returned plan description. The server uses a deterministic or constrained sampling strategy to reduce randomness, which facilitates stable parsing and reduces post-processing errors.

The generative AI model outputs a natural-language description of an education plan. The server parses the output using pattern recognition rules or a lightweight parser that identifies step markers, time expressions in minutes, activity type phrases such as “review,” “practice,” and “quiz,” and topic keywords. The server maps the parsed steps to internal representations, building an education plan data structure that specifies, for each step, fields such as step identifier, step type, targeted subject or topic, target difficulty range, requested number of problems, and allocated time. The server further resolves generic descriptions like “some practice problems” into concrete selections from the “Problem” table by applying selection rules that match topic tags, difficulty tags, and problem type tags.

The server then stores the education plan data in the relational database, associating it with the learner identifier and a session identifier. The server also transmits the plan data to the corresponding terminal. Because the plan data is stored in a structured format, the server can efficiently update or partially reconfigure the plan in later iterations without regenerating or re-downloading the full content, thereby reducing communication load and storage overhead.

The terminal receives the education plan data and displays a structured view to the user. The terminal presents to the user the sequence of steps, each with a description, an estimated duration, and any special instructions. The terminal queries the server or a content cache for problem data identified by the problem identifiers in the plan data. When the user starts a plan step, the terminal displays the associated problems or learning materials, tracks the time, and records all interactions such as answers, hint requests, navigation actions, and early step termination.

The server processes the newly collected response information to generate updated learning history information. The server inserts each response record into the “AnswerLog” table and updates auxiliary tables that store incremental aggregates or rolling statistics. In one embodiment, the server maintains summary tables that precompute topic-wise counts, averages, and rolling windows, thereby eliminating repeated full scans of the answer logs.

This precomputation improves processing speed and reduces computational load when recalculating performance indices for each subsequent plan generation.

The server also processes emotion state information. The terminal or a connected sensor device captures expression information, such as facial images, and voice information, such as speech signals, and transmits features derived from them to the server. The server extracts additional features locally or accepts preprocessed features from the terminal. In one embodiment, the server applies a convolutional neural network to facial image feature maps and a recurrent or transformer-based neural network to acoustic feature sequences in order to infer emotion labels such as “frustrated,” “confident,” or “tired.” The server additionally analyzes character information from user-entered text, computing sentiment scores using a text classification model. The server fuses these signals to estimate an emotion state vector per session or per step.

The server includes emotion state features among the performance indices used to generate the next prompt sentence. For example, if the emotion features indicate increased frustration and prolonged response times, the server adjusts the template for the prompt sentence to request more review steps or to limit difficulty escalation. An example of such a modified prompt sentence is:

“You are an AI tutor. Student A has an accuracy of 58% on quadratic equations, with an average answer time of 80 seconds. Recent emotion indicators suggest increased frustration and fatigue during more complex problems that require completing the square. Create a 30-minute personalized study plan that reduces cognitive load by including shorter review segments, simpler practice problems at the beginning, and clear explanations. Gradually increase difficulty only if the student demonstrates improvement. Provide the output as a numbered list of steps with estimated time and activity type.”

The server thus uses emotion state information not merely for display, but as a parameter that changes the internal control flow and content of the generated education plan data through modified prompt sentences. This linkage between sensor-derived emotion features, prompt construction, and subsequent data structures enables the computer system to control its internal states and external outputs in a technically meaningful way.

The server forms a closed computational loop: learning activity information and behavior tendency information are continuously acquired and structured; performance indices and evaluation results are recalculated; prompt sentences are dynamically updated; the generative AI model is called with updated prompts; and new or modified education plan data are generated, stored, and executed. This continuous loop improves the precision and timeliness of educational content adaptation, and also improves computer resource utilization by enabling incremental updates instead of recreating entire plans. The server exploits the structured plan representation and precomputed indices to minimize redundant computation and network transfers.

The system provides technical effects beyond merely automating human tutoring logic. For example, the server reduces latency in plan generation by (i) precomputing performance indices, (ii) using constrained prompt templates that lead to more predictable generative AI outputs, and (iii) storing education plan data in normalized tables that support fast partial updates. The server improves plan accuracy through machine learning-based estimation of comprehension level and emotion state, and uses these estimates as high-dimensional feature vectors in prompt sentences rather than simple thresholds. The server also reduces communication load between the server and terminals by transmitting compact, identifier-based education plan data structures instead of repeated full text contents of problems and explanations.

The server processes features and updates models according to algorithmic rules that are not typically performed by human tutors. For example, the server aggregates large-scale logs across many sessions and computes rolling-window statistics for each learner and topic, which are mathematically optimized to reduce noise and highlight trends. The server executes neural network inference with hundreds of parameters across multi-dimensional feature vectors, which enables detection of subtle patterns not evident to human observers. The server then uses this analysis to construct prompt sentences that encode constraints and priorities in a machine-oriented format, enhancing inter-module coordination. Thus, the system uses AI models and algorithmic logic in a non-conventional, system-level way, improving how the computer stores, processes, and moves data.

In alternative embodiments, the server deploys the generative AI model locally on a dedicated accelerator device such as a graphics processing unit or a tensor processing unit.

The server loads a transformer-based language model with a specified number of layers and attention heads, and uses a quantized representation of model weights to reduce memory usage. The server executes model inference using batched prompt sentences for multiple learners, thereby increasing throughput. The server uses scheduling policies that balance CPU-bound tasks (such as database aggregation) and accelerator-bound tasks (such as neural network inference), which leads to improved hardware utilization and reduced overall processing time.

In another embodiment, the server uses different plan generation policies for different learning fields. For example, for language learning, the server may include activity types such as “reading comprehension” and “vocabulary review” in the plan data. The server changes the template for the prompt sentence accordingly, and the generative AI model returns appropriate activities. The underlying mechanisms of structured performance indices, dynamic prompt construction, and machine-readable plan data conversion remain the same, demonstrating that the architecture is domain-independent but technically specific.

In another embodiment, the server supports direct user-specified prompt sentences that are enriched with system data. The user enters a free-text query such as:

“Evaluate my progress in quadratic equations this week and tell me what I should focus on tomorrow.”

The terminal transmits this query to the server. The server retrieves recent performance indices and emotion state information for the user and combines them with the user's query in a composite prompt sentence such as:

“User request: ‘Evaluate my progress in quadratic equations this week and tell me what I should focus on tomorrow.’ System statistics: correctness rate this week is 60%; average answer time is 70 seconds; 40 problems attempted; main weakness: completing the square; main strength: factoring; recent emotion signals indicate moderate frustration with more abstract word problems. Based on these data, provide an explanation of the learner's current status and propose a 30-minute plan focusing on improving skills in completing the square while maintaining strength in factoring.”

The server sends this composite prompt sentence to the generative AI model, receives an explanation and plan description, and converts the plan part into plan data. The terminal displays the explanation to the user while executing the plan data in the same structured manner. In this way, user-initiated free-text prompts are integrated into the closed loop in a technically constrained and data-aware fashion.

Through the foregoing embodiments, the server, in cooperation with the terminals and users, implements the claimed system in a way that leverages specific hardware and software configurations, defined data structures, and controlled AI model interactions. The system thereby improves the functioning of the computer itself by enhancing how learning data are structured, how performance indices are computed and stored, how prompt sentences are generated and refined, how generative AI outputs are normalized into machine-readable plans, and how plans are iteratively updated based on new learning history and emotion state information.

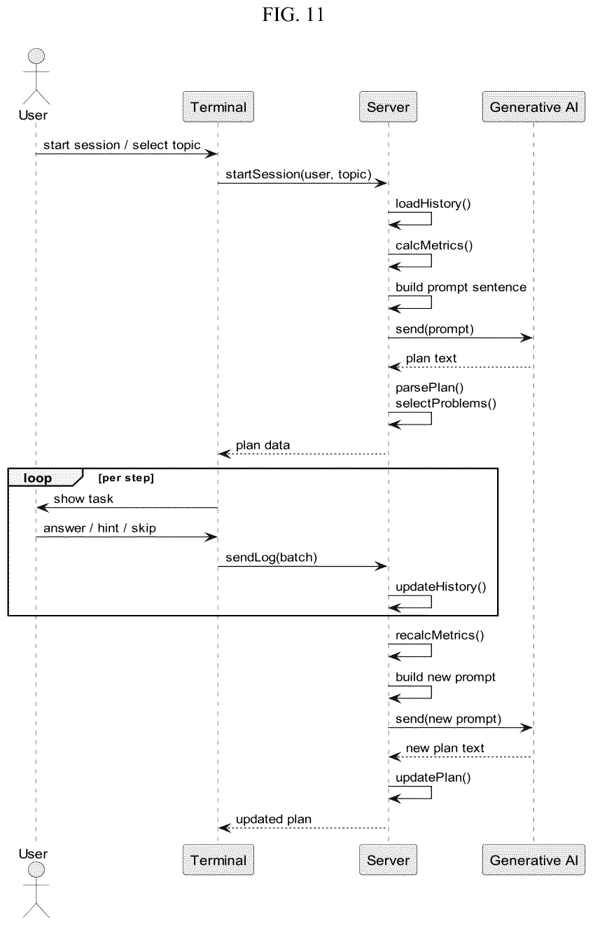

The following describes the processing flow using FIG. 11.

### Step 1:

The user operates the terminal to start a learning session and select a target subject and topic.

The terminal receives as input a user identifier stored in local memory, a list of available subjects and topics obtained from the server in advance, and user operations such as taps or clicks on the user interface.

The terminal processes this input by generating a new session identifier, associating it with the user identifier and selected subject and topic, and recording a session start timestamp.

The terminal outputs a structured session-start message that includes the user identifier, the session identifier, the selected subject and topic, and the start timestamp, and transmits this message to the server via a network.

### Step 2:

The server receives the session-start message and initializes internal data structures for the session.

The server receives as input the session-start message including the user identifier, session identifier, selected subject, selected topic, and timestamp.

The server processes this input by validating the user identifier, checking authorization, and writing a new record into a “Session” table in a storage device, with fields for the user, subject, topic, and start time.

The server outputs an acknowledgment and a request context object that contains normalized identifiers for the subject and topic, and returns this context to the terminal to confirm session initialization.

### Step 3:

The server retrieves learning history information and behavior tendency information for the user.

The server receives as input the user identifier and the normalized subject and topic identifiers from the request context.

The server processes this input by executing database queries against an “AnswerLog” table and related tables to obtain records of past answers, timestamps, correctness flags, response times, hint usage flags, and other operation logs for the same user and subject/topic. The server also obtains any precomputed aggregates from summary tables.

The server outputs learning history information in the form of in-memory data structures, such as arrays or lists of log entries and aggregate records, to be used in subsequent performance index computation.

### Step 4:

The server computes performance indices and evaluation results based on the retrieved learning history information.

The server receives as input the learning history information, including arrays of correctness flags, response times, difficulty levels, and hint usage counts for relevant topics.

The server processes this input by performing statistical operations such as counting, summing, and averaging, to obtain values for correctness rate, average answer time, distribution of answer times, number of attempted problems, and support request frequency.

The server further processes the aggregated values by constructing feature vectors and applying a machine learning model, such as a neural network or gradient boosting model, to compute evaluation results including a comprehension level score, a learning progress score, and a learning characteristic profile for the user.

The server outputs a set of performance indices and evaluation results as structured numerical and categorical data, ready to be embedded into a prompt sentence.

### Step 5:

The server constructs a prompt sentence for the generative AI model based on the performance indices and evaluation results.

The server receives as input the performance indices (for example, correctness rate 58%, average answer time 80 seconds, number of attempts 25, hint usage frequency) and evaluation results (for example, low comprehension for a specific subtopic, moderate progress, high support dependency).

The server processes this input by applying a prompt template stored in a configuration file, replacing placeholders with actual numerical values and descriptors derived from the indices and evaluation results. The server ensures that the prompt sentence includes sections describing the learner's status, constraints on total study time, desired activity types, and required output format.

The server outputs a text string representing the prompt sentence, such as:

“You are an AI tutor. Analyze the following learner history for Student A in the subject of mathematics, focusing on the topic ‘quadratic equations’. The learner's overall correctness rate on this topic is 58%, and the average answer time is 80 seconds per problem. The learner has attempted 25 problems in the last week, frequently requested hints, and showed particular difficulty with tasks that require completing the square without step-by-step guidance. Create a 40-minute personalized study plan including: (1) short conceptual review steps, (2) a sequence of practice problems with gradually increasing difficulty, and (3) a short quiz at the end to confirm understanding. Provide the output as a numbered list of steps, each with an estimated time in minutes and a brief description of the activity.”

### Step 6:

The server invokes the generative AI model with the constructed prompt sentence and receives an education plan description.

The server receives as input the prompt sentence text and configuration parameters for the generative AI model, such as maximum token count and sampling settings.

The server processes this input by formatting a model request payload that includes the prompt sentence and parameters, transmitting it to the generative AI model via an API or internal inference engine, and managing the communication session until the model completes generation. The generative AI model internally performs tokenization, embedding, multi-layer attention and feedforward computations, and autoregressive decoding to produce an output text sequence conditioned on the prompt.

The server outputs the model's text response, which typically contains a numbered list of plan steps, each describing an activity type, time allocation, and focus topic.

### Step 7:

The server parses the education plan description and converts it into machine-readable education plan data.

The server receives as input the text output from the generative AI model, containing natural-language descriptions of steps, durations, and activities.

The server processes this input by applying parsing rules and pattern-matching logic to detect step boundaries, extract estimated time values, classify activities as review, practice, or quiz based on keywords, and identify topic names or subtopics mentioned in the text. The server maps these elements to internal codes for step type, topic identifier, time allocation in minutes, and required problem counts, and constructs a structured plan data object with fields such as step identifier, step type, topic code, duration, and target difficulty.

The server outputs education plan data in a machine-readable format, such as an in-memory object or record list, that is ready to be stored and further enriched with concrete problem identifiers.

### Step 8:

The server selects concrete problem items and finalizes the education plan data.

The server receives as input the structured education plan data that specifies, for each step, the topic, activity type, estimated duration, and desired problem count or difficulty.

The server processes this input by querying a “Problem” table or problem bank using selection criteria derived from each plan step, such as topic tags, difficulty ranges, and problem types (for example, multiple-choice or free-response). The server executes queries that filter and sort problem records and selects a set of problem identifiers for each step according to the requested number and difficulty distribution. The server inserts these problem identifiers into the education plan data for each step.

The server outputs a finalized education plan data structure that includes, for each step, fields for step type, time allocation, topic code, and an ordered list of problem identifiers, and stores this structure in the storage device associated with the user and session identifiers.

### Step 9:

The server delivers the finalized education plan data to the terminal.

The server receives as input the finalized education plan data and the session context that includes terminal identification and communication channel information.

The server processes this input by serializing the education plan data into a compact transmission format, embedding minimal descriptive text and references to content identifiers, and sending the serialized data over the network to the terminal via an application protocol. The server may compress or batch multiple message components to reduce communication overhead.

The server outputs a network response message that the terminal receives as the session's individualized education plan.

### Step 10:

The terminal receives the education plan and prepares the user interface for plan execution.

The terminal receives as input the network response containing the education plan data with step definitions and problem identifiers.

The terminal processes this input by deserializing the plan data, storing it in local memory or cache, and constructing user interface elements that display the step sequence, activity types, and estimated times. The terminal also prepares internal structures to track completion state for each step and problem.

The terminal outputs a visual representation of the plan on the display and an internal control state that is ready to manage navigation between steps and problems during execution.

### Step 11:

The terminal presents learning tasks to the user according to the education plan and records user interactions.

The terminal receives as input the education plan data for the current step, problem identifiers, and user actions (for example, starting a step, submitting an answer, requesting a hint, or skipping a problem).

The terminal processes this input by retrieving the problem statement and related content either from a local cache or via request to the server, displaying the content on the screen, starting timers when a problem is shown, and stopping timers when the user submits an answer or leaves the problem. The terminal records detailed logs including timestamps, problem identifiers, answer content, response time, hint usage events, and navigation actions in a local buffer.

The terminal outputs structured response information records for each interaction, which are later transmitted to the server as batches of learning activity information and behavior tendency information.

### Step 12:

The terminal transmits response information batches to the server, and the server updates learning history information.

The terminal receives as input the buffered response information records accumulated during one or more steps.

The terminal processes this input by packaging the records into a batch object that includes user identifier, session identifier, and an array of interaction entries. The terminal sends this batch to the server via the network.

The server receives as input the batch object containing multiple response information entries. The server processes this input by validating each entry, determining correctness by comparing answer content against correct answers in the problem bank if necessary, and inserting the records into the “AnswerLog” table. The server may update or create summary records in auxiliary tables to maintain rolling aggregates.

The server outputs updated learning history information in persistent storage, reflecting the new answers, times, and behavior tendencies associated with the user and session.

### Step 13:

The server recalculates performance indices and dynamically updates the prompt sentence and education plan.

The server receives as input the updated learning history information including the newly added response information records for the current session.

The server processes this input by re-running statistical computations over recent data segments, updating correctness rates, response time statistics, and support request frequencies. The server refreshes feature vectors for its evaluation model and recomputes comprehension level and learning progress scores. Based on these recalculated indices and scores, the server reconstructs or modifies a prompt sentence using its template, possibly shortening remaining plan duration, shifting activity types, or emphasizing specific subtopics.

The server then sends the updated prompt sentence to the generative AI model, receives a revised plan description, parses it, and updates the education plan data in the storage device, optionally changing future steps within the same ongoing session or preparing a new plan for the next session.

The server outputs a revised education plan data structure, which can be transmitted to the terminal or used in subsequent sessions, thereby adaptively changing the plan over time.

### Step 14:

The server incorporates emotion state information into prompt construction and plan adaptation when available.

The server receives as input emotion state features derived from terminal-side or server-side analysis of expression information, voice information, and character information for the user, combined with existing performance indices.

The server processes this input by augmenting the feature vectors with emotion-related dimensions such as frustration level, engagement score, or fatigue index, and by altering the prompt template selection or specific phrases to request more supportive or less demanding activities from the generative AI model. The server may, for instance, reduce requested difficulty escalation or increase the proportion of review steps in the prompt sentence.

The server outputs modified prompt sentences and resulting education plan data that are aligned with both performance and emotion states, leading to technically different plan structures (for example, re-ordered steps, adjusted time allocations, and modified distributions of problem difficulties) compared to plans generated without emotion state information.

### Step 15:

The user optionally issues a direct prompt sentence, and the server enriches it with system data for generative AI processing.

The user provides as input a free-text query through the terminal interface, such as “Evaluate my progress in quadratic equations this week and tell me what I should focus on tomorrow.” The terminal processes this input by packaging the text with the user identifier and current context (subject, topic) and sending it to the server. The server receives the query text and processes it by retrieving recent performance indices and emotion state information for the user, then constructing a composite prompt sentence that includes both the user's request and system-provided statistics, for example:

“User request: ‘Evaluate my progress in quadratic equations this week and tell me what I should focus on tomorrow.’ System statistics: correctness rate this week is 60%; average answer time is 70 seconds; 40 problems attempted; main weakness: completing the square; main strength: factoring; recent emotion signals indicate moderate frustration with more abstract word problems. Based on these data, provide an explanation of the learner's current status and propose a 30-minute plan focusing on improving skills in completing the square while maintaining strength in factoring.”

The server then sends this composite prompt sentence to the generative AI model, receives an explanation and plan text, and converts the plan portion into machine-readable education plan data.

The server outputs a natural-language explanation for display to the user and a structured plan for subsequent execution by the terminal.

### Step 16:

The terminal updates its display and control flow according to revised or newly generated education plan data.

The terminal receives as input updated education plan data and, optionally, explanatory text from the server.

The terminal processes this input by updating its locally stored plan data structures, adjusting the order and content of upcoming steps, and refreshing the user interface to indicate new or modified sessions. If changes affect the current session, the terminal may interrupt or reschedule subsequent steps according to newly received definitions.

The terminal outputs an updated user interface view that reflects the adaptive education plan and corresponding navigation controls for the user, while maintaining synchronized state with the server regarding completed and pending steps.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented learning support systems typically rely on static recommendation logic and coarse-grained user modeling. In many such systems, a server merely retrieves pre-defined learning materials from a storage device based on simple rules such as grade level or past test scores, and then delivers these materials to a terminal. These systems often do not continuously integrate fine-grained behavioral data such as per-question response time, hint usage, or navigation patterns, and they do not dynamically update an education plan in real time during an ongoing learning session. As a result, the server fails to utilize available computational resources and data structures to produce high-resolution learner models and cannot adaptively coordinate learning content at the level of individual interactions.

Furthermore, known systems that employ machine learning techniques generally confine such techniques to an offline recommendation phase. A typical server may train or apply a model to cluster learners or rank content items, but the internal structure of the education plan, including learning order, time allocation, and explanation style, is still generated and maintained by fixed, hand-crafted logic. Consequently, the server architecture does not fully leverage generative information processing models that can flexibly generate or revise educational content control information in response to evolving learner states. This limits the system's ability to improve content selection and presentation at the system level, and constrains the adaptability and responsiveness of the learning platform.

In addition, in many existing architectures, the generation and use of prompts for a generative AI model are ad hoc and not integrated as first-class computational operations. Prompts are often manually crafted, are not systematically constructed from structured learner characteristic information and education plan data, and are not re-generated as the learner's behavior changes. Therefore, the server's processing pipeline cannot effectively orchestrate iterative interactions with a generative AI model, and cannot maintain consistency between the internal learner model, the education plan, and the generated explanations or feedback.

Moreover, although some systems attempt to infer emotional states of learners, such information is usually processed separately from core content-planning logic. Emotional signals, if used at all, are typically employed for simple cosmetic changes, such as displaying motivational messages, and are not incorporated as structured parameters into the computational process that generates or updates an education plan via machine learning and generative modeling. This separation leads to underutilization of emotion-related data and prevents the system from systematically adapting content selection, presentation order, or explanation style to the learner's emotional state.

Accordingly, there is a need for an improved computer-implemented learning support system in which a server-side processor: (i) acquires and stores fine-grained behavior information from an information terminal; (ii) executes statistical learning processes to compute detailed learner characteristic information; (iii) programmatically constructs and regenerates prompt sentences that encode both learner characteristics and education plan data as structured inputs to a generative information processing model; (iv) obtains, from the generative model, educational content control information that is closely aligned with the internal plan data; and (v) dynamically updates the education plan and associated content control information in real time based on both behavioral and emotional state information. Such improvements in the data flow, model orchestration, and prompt-driven generation of control information can enhance the efficiency, adaptability, and technical performance of the underlying computer system for personalized education.

The specific processing by the specific processing unit 290 of the data processing device 12 in Application Example 1 is realized by the following means.

The present invention provides a server comprising a processor and a storage device, the processor being configured to acquire, from an information terminal operated by a learner, behavior information including a learning history and a behavior pattern related to learning tasks, the behavior information including at least a response result, a response time, a browsing history of materials, and a reference history of support information, and to store the behavior information in the storage device; to execute, on the basis of the behavior information stored in the storage device, a statistical learning process by using a machine learning program so as to calculate learner characteristic information representing, for each learner, at least a degree of understanding, a degree of acquisition, and a learning tendency; to select, on the basis of the learner characteristic information and attribute information of educational materials, a plurality of educational materials and to generate education plan data including at least a learning order and a learning time allocation; to generate, by using the education plan data, the learner characteristic information, and condition information including a candidate set of the educational materials, an instruction sentence in a natural language, to construct a prompt sentence including the instruction sentence as an input to a generative information processing model, and to input the prompt sentence to the generative information processing model so as to obtain educational content control information including at least explanatory information, learning procedures, and learning content details corresponding to the education plan data, and to store the educational content control information in association with the education plan data in the storage device; to acquire, while the learner executes the educational materials via the information terminal, progress information sequentially transmitted from the information terminal, the progress information including at least a response status, an operation history, and a support request, and to monitor, in real time, the degree of understanding and a learning progress of the learner while temporally updating the degree of understanding and the learning progress on the basis of the progress information; and, when an update result of the degree of understanding and the learning progress satisfies a predetermined condition, to dynamically update the education plan data by changing a selection and a presentation order of the educational materials included in the education plan data and/or by adding a new educational material, to regenerate the prompt sentence on the basis of the updated education plan data, to re-input the regenerated prompt sentence to the generative information processing model, to obtain, in real time, adaptive educational content control information from the generative information processing model, and to transmit the adaptive educational content control information to the information terminal. This enables the computer-implemented learning support system to tightly integrate machine-learned learner characteristics, programmatically generated prompt sentences, and outputs of a generative information processing model, thereby improving the server's capability to dynamically plan, control, and adapt educational content in real time based on both behavioral and emotional state data, and enhancing the technical performance, responsiveness, and personalization of the overall system.

The term “system” refers to an arrangement of hardware components, software components, and communication interfaces that cooperate to perform processing related to provision, control, and adaptation of educational content for a learner.

The term “processor” refers to a hardware processing unit, such as a central processing unit or other information processing circuitry, that executes instructions of one or more programs to perform the functions described in the claims, including data acquisition, analysis, planning, and interaction with a generative information processing model.

The term “storage device” refers to a hardware memory resource, such as a main memory, auxiliary memory, or other non-transitory computer-readable medium, that stores behavior information, learner characteristic information, education plan data, educational content control information, and programs used by the processor.

The term “information terminal” refers to a user-operated computing device, such as a portable communication device, a tablet-type device, or a general-purpose computing device, that presents educational materials to a learner, receives inputs from the learner, and transmits behavior and progress information to the server.

The term “learner” refers to a user who interacts with the information terminal for the purpose of acquiring knowledge or skills through educational materials controlled by the system.

The term “behavior information” refers to data indicating how a learner interacts with educational materials and the information terminal, including a learning history and a behavior pattern related to learning tasks.

The term “learning history” refers to accumulated records of a learner's past learning activities, including at least which learning tasks were attempted, which responses were given, and whether such responses were correct or incorrect.

The term “behavior pattern” refers to characteristic tendencies in a learner's actions during learning activities, including patterns in task selection, time usage, request for support information, and navigation among materials.

The term “learning task” refers to a unit of educational activity presented to the learner, such as a question, a problem, an exercise, or a specific instructional step.

The term “response result” refers to data representing an outcome of a learner's response to a learning task, including information indicating correctness, type of response, or other evaluation metrics.

The term “response time” refers to a time period measured from when a learning task is presented to the learner until the learner submits a response or completes an associated operation.

The term “browsing history of materials” refers to data indicating which educational materials have been displayed or accessed on the information terminal and in what order or for what duration.

The term “reference history of support information” refers to data indicating which explanatory contents, hints, or other support information the learner has requested or viewed during learning activities.

The term “statistical learning process” refers to a computational process that applies a machine learning algorithm, such as a model trained on data, to input behavior information in order to infer or estimate properties related to a learner, including degrees of understanding and learning tendencies.

The term “machine learning program” refers to software implementing a machine learning algorithm or model, such as a neural network or other statistical model, which is executed by the processor to analyze behavior information and produce learner characteristic information.

The term “learner characteristic information” refers to data representing properties of a learner as inferred by the system, including at least a degree of understanding, a degree of acquisition, and a learning tendency for one or more topics or skills.

The term “degree of understanding” refers to a numerical or categorical measure indicating how well a learner comprehends a particular concept, topic, or set of learning tasks.

The term “degree of acquisition” refers to a numerical or categorical measure indicating the extent to which a learner has acquired a skill or mastered a topic, based on performance and behavior information.

The term “learning tendency” refers to a description or measure of a learner's characteristic learning style or behavior, such as preference for certain types of materials, use of hints, or pace of study.

The term “educational materials” refers to digital content items provided for learning purposes, including, for example, explanations, example problems, quizzes, exercises, videos, or other instructional resources.

The term “attribute information of educational materials” refers to metadata associated with educational materials, such as topic, difficulty level, format, prerequisite relationships, or estimated study time.

The term “education plan data” refers to structured data defining a planned sequence and configuration of educational materials to be provided to a learner, including at least a learning order and a learning time allocation.

The term “learning order” refers to an arrangement or sequence in which educational materials or learning tasks are to be presented to a learner.

The term “learning time allocation” refers to an assignment of estimated or target time durations for engagement with specific educational materials or portions of an education plan.

The term “instruction sentence” refers to a natural-language sentence or set of sentences that describes to a generative information processing model what kind of educational content control information should be generated under given conditions.

The term “condition information” refers to data specifying constraints, parameters, learner characteristics, and candidate educational materials that define the context in which a generative information processing model is to produce educational content control information.

The term “candidate set of the educational materials” refers to a collection of educational materials selected as possible elements to be used or arranged in an education plan for a learner.

The term “prompt sentence” refers to a natural-language or semi-structured text input, including an instruction sentence and related context information, provided to a generative information processing model to cause the model to output educational content control information.

The term “generative information processing model” refers to a model, such as a generative AI model, that has been trained on data to generate new information, including natural-language text or structured output, in response to an input prompt sentence.

The term “educational content control information” refers to information generated by the generative information processing model that specifies or refines how educational materials and explanations are to be presented, including explanatory information, learning procedures, and detailed learning contents.

The term “explanatory information” refers to natural-language descriptions or explanations intended to clarify concepts, procedures, or problem-solving methods related to educational materials.

The term “learning procedures” refers to instructions or sequences of steps that guide a learner through a process of studying a topic or solving a problem.

The term “learning content details” refers to fine-grained descriptions or parameters of learning content items, such as problem variations, step-by-step hints, or tailored examples.

The term “progress information” refers to data indicating the current or recent state of a learner's interaction with educational materials, including a response status, an operation history, and support requests.

The term “response status” refers to information describing the learner's current or recent responses to learning tasks, including completion, correctness, or attempts.

The term “operation history” refers to logs of user operations on the information terminal, such as selections, clicks, scrolling, navigation, or timing of inputs.

The term “support request” refers to an indication that the learner has requested additional help, such as hints, detailed explanations, or alternative examples.

The term “learning progress” refers to data or metrics representing the learner's advancement through an education plan or mastery of subjects over time.

The term “predetermined condition” refers to a criterion or set of criteria defined in advance, such as threshold values for understanding or progress, which determine when the education plan data is to be updated.

The term “adaptive educational content control information” refers to educational content control information that has been generated or revised in accordance with updated learner characteristic information or learning progress, so as to adapt to the learner's current state.

The term “image data” refers to digital data representing visual information, such as still images or moving images, obtained from an imaging device or display capture.

The term “acoustic data” refers to digital data representing sound, including speech, captured by a sound input device such as a microphone.

The term “character string data” refers to digital textual data, including characters, words, or sentences, obtained from inputs such as typed text, chat logs, or annotations.

The term “emotion estimation process” refers to a computational process that analyzes at least image data, acoustic data, and character string data to infer an emotional state of a learner.

The term “facial expression recognition process” refers to a process that analyzes image data of a learner's face to detect or classify facial expressions indicative of emotional states.

The term “voice feature analysis process” refers to a process that analyzes acoustic features of a learner's speech, such as pitch, volume, and tone, to infer emotional cues.

The term “context analysis process” refers to a process that analyzes character string data, such as textual content of learner inputs, to determine emotional or attitudinal information from linguistic context.

The term “emotion information” refers to data representing an inferred emotional state of a learner, such as stress, frustration, engagement, or satisfaction.

The term “emotional state” refers to a psychological condition of a learner at a given time, inferred from multimodal input data, that may affect learning behavior or receptivity to content.

The term “threshold condition” refers to one or more limit values or decision rules applied to emotion information or other metrics, which when satisfied trigger a change in processing, such as modification of an education plan.

The term “additional conditions” refers to extra constraints, parameters, or instructions added to a prompt sentence to cause a generative information processing model to generate content that is adapted to specific factors, such as a learner's emotional state.

The term “updated educational content control information” refers to educational content control information that has been newly generated or modified by the generative information processing model, taking into account additional conditions such as emotional state or updated education plan data.

The term “explanatory sentences” refers to natural-language sentences that provide explanations, clarifications, or instructional guidance to the learner.

The term “support messages” refers to messages presented to the learner, including encouragement, guidance, or advice, which are designed to support motivation or understanding.

The term “presentation order” refers to the sequence in which educational materials, explanations, or messages are shown to the learner on the information terminal.

The term “adjusted in accordance with the emotional state” refers to having parameters such as content selection, difficulty, tone, or style modified based on the emotion information representing the learner's emotional state.

In one embodiment, a server, a terminal, and a user cooperate to implement the claimed invention. The server includes at least one processor, a main memory, a non-transitory storage device, and a network interface. The terminal includes at least one processor, a display unit, an input unit, a memory, and a communication module. The user operates the terminal to perform learning activities, and the server executes specialized software modules to acquire, analyze, and control educational content based on behavior information and emotional state information.

The server executes an operating system such as a general-purpose server operating system, and runs an application stack that includes a web application framework, a database client, a machine learning library, and a generative AI client library. As one example, the server executes a web application framework running on a virtual machine in a cloud computing environment. The server communicates with a database service that functions as the storage device, for example a managed NoSQL database. In addition, the server executes a machine learning library such as a tensor-based computation framework, and a neural network framework such as a deep learning framework, to perform statistical learning processes. The server also communicates with a generative AI model via an API over a communication network.

The server stores data in the storage device according to defined data structures. For example, the server stores behavior information in records keyed by a learner identifier. Each record may include arrays of events, where each event includes a task identifier, a response result, a response time, a content identifier for an educational material, and flags indicating whether support information was requested. The server stores learner characteristic information as vectors or maps, where each dimension corresponds to a concept or skill and stores numerical values representing a degree of understanding, a degree of acquisition, and learning tendencies. The server also stores education plan data as structured objects that include ordered lists of educational material identifiers, estimated time allocations, prerequisite relationships, and control flags for branching or remediation. Educational content control information is stored as text fields and structured metadata that describe explanatory information, learning procedures, and detailed learning contents associated with each step of the education plan.

The server uses a machine learning library to implement a statistical learning process that transforms behavior information into learner characteristic information. In one embodiment, the server uses a feedforward neural network having multiple layers. The server defines input features such as: average response time per topic, recent correctness ratio per topic, frequency of support requests, number of attempts per problem, time-of-day usage patterns, and session lengths. The server normalizes these features and inputs them into the neural network. The neural network includes at least one hidden layer with a rectified linear unit activation function and an output layer that produces continuous values between zero and one representing degrees of understanding, degrees of acquisition, and engagement indices for multiple topics.

The server trains this neural network offline using historical data. During training, the server computes a loss function, for example a mean squared error between predicted mastery values and ground-truth labels derived from assessment scores or expert annotations. The server updates weights of the neural network by applying an optimization algorithm, such as stochastic gradient descent with momentum or an adaptive gradient method. The server may apply data augmentation techniques, such as adding small noise to response times or sampling different time windows of behavior history, to improve robustness. As a result, the server obtains trained model parameters that are deployed in the production environment.

During runtime, the server loads the trained model from the storage device into memory and executes the forward computation on each new batch of behavior information, thereby efficiently computing updated learner characteristic information.

The server generates education plan data by combining the learner characteristic information with attribute information of educational materials. Educational materials are stored in the storage device with metadata describing topic categories, difficulty levels, estimated time, and prerequisite relationships. The server uses an algorithm that selects candidate materials for a learner by applying rules such as: if a degree of understanding for a topic is below a threshold, the server prefers materials tagged as “introductory” for that topic; if a degree of acquisition is high, the server may skip or compress introductory materials. The server then arranges selected materials in a sequence that respects prerequisite relationships and balances review and new content, and assigns time allocations based on difficulty and learner pace.

This produces education plan data that is more granular and structurally rich than conventional static course schedules.

The server interacts with a generative AI model by constructing and sending a prompt sentence. The server uses a generative AI client library to format an HTTP request to a generative AI endpoint provided by a model hosting service, such as a large language model deployed on a remote computing cluster. The generative AI model may be implemented as a transformer-based neural network with multiple attention layers and a large number of parameters. The model is trained on large-scale text corpora and fine-tuned for instructional output.

The server constructs a prompt sentence by converting the education plan data, learner characteristic information, and attribute information of candidate educational materials into a natural-language description. For example, the server may generate the following prompt sentence:

“You are an AI tutoring assistant. The learner is studying differential calculus and has low mastery of the chain rule and moderate mastery of basic derivatives. The candidate contents are: (1) ‘Introductory explanation of derivatives’ (easy), (2) ‘Basic derivative practice problems’ (easy), (3) ‘Step-by-step explanation of the chain rule’ (medium), (4) ‘Chain rule practice problems’ (medium). Create a personalized learning plan for the next 60 minutes that helps the learner strengthen understanding of the chain rule. Output a structured list of steps, each with a title, a short description, and an estimated time.”

The server transmits this prompt sentence as part of the request body to the generative AI model. The generative AI model processes the prompt sentence according to its transformer architecture. Specifically, the model tokenizes the text, encodes tokens into embeddings, applies self-attention layers to compute context-aware representations, and generates output tokens that are decoded into natural-language text representing educational content control information. The server receives this text as a response.

The server parses the response and extracts educational content control information such as step titles, descriptions, and time estimates. The server associates each step with actual educational material identifiers in the storage device. The server then stores this educational content control information as part of the education plan data. Since the server constructs the prompt sentence programmatically from structured data and parses the generative output back into structured form, the system achieves a closed-loop integration between deterministic data structures and generative AI outputs. This integration improves internal consistency and reduces errors that would arise from manually crafted prompts and ad hoc interpretation.

The server also generates prompt sentences for real-time feedback. In one example, when the learner repeatedly fails a particular problem, the server constructs a prompt sentence that includes the problem statement, the learner's incorrect answer, and known weaknesses inferred from learner characteristic information. For example, the server may generate:

“The learner is solving the following problem: ‘Find the derivative of y=(3x²+2x+1)⁴.’

The learner answered incorrectly and seems to have difficulty applying the chain rule.

Provide a short, step-by-step hint that guides the learner to identify the outer function and the inner function, and explain how to differentiate each part. Do not give the final numeric expression. The explanation should be understandable to a high school student.”

The server transmits this prompt sentence to the generative AI model. The generative AI model outputs a short hint. The server receives the hint, attaches metadata such as the related problem identifier and difficulty level, and stores it in the storage device. The terminal then retrieves and displays the hint under the corresponding problem. By managing feedback generation through structured prompt construction and model interaction, the server provides fine-grained, context-aware feedback that would be difficult to generate with fixed rule-based templates.

The server further uses emotional state information to modify the education plan and prompt sentences. The terminal captures image data from a camera, acoustic data from a microphone, and text-based inputs from the user. The terminal transmits these data to the server. The server executes an emotion estimation process using a combination of models. For facial expression recognition, the server may use a convolutional neural network that classifies facial expressions into categories such as neutral, frustrated, or engaged. For voice feature analysis, the server may extract prosodic features such as pitch, intensity, and speaking rate, and input them to a classifier such as a recurrent neural network or a gradient boosting machine. For context analysis of character string data, the server may use a natural-language classifier that detects sentiment or frustration keywords.

The server integrates outputs of these models into emotion information representing an emotional state of the learner. The server stores this emotion information as part of the learner characteristic information. When the emotion information satisfies a threshold condition, such as a high frustration score or a low engagement score, the server modifies the prompt sentence to include additional conditions. For example, the server may generate:

“The learner currently appears frustrated based on recent facial expressions and tone of voice. Adjust the explanations to use simpler language, add more encouragement, and reduce the number of problems in each step. Propose a revised plan that keeps the total time within 30 minutes.”

By including such additional conditions in the prompt sentence, the generative AI model is guided to produce educational content control information that is adapted to the learner's emotional state. The server then dynamically updates the education plan data by replacing or reordering steps and by inserting supportive messages. This emotional-state-aware control is more than cosmetic; it is implemented as a formal parameter in the data flow and directly affects content selection and sequencing within the server's control logic.

The terminal executes a client application that communicates with the server over a network protocol such as HTTPS. The terminal receives education plan data and educational content control information as structured responses, typically encoded in a machine-readable format.

The terminal maps content identifiers to local rendering components and displays educational materials on the display unit. The terminal collects user interactions, including problem responses, time stamps of actions, scrolling behavior, and explicit help requests. The terminal packages these into behavior information objects and transmits them to the server. Because the terminal sends detailed, timestamped data rather than aggregated scores, the server can update learner characteristic information with high temporal resolution, enabling fast adaptation.

The user operates the terminal to answer questions, read explanations, and request hints. The user perceives real-time changes in the presented materials, such as additional foundational content being inserted or advanced topics being postponed. From the user's perspective, the system behaves as a responsive tutoring environment; from the technical perspective, this behavior results from synchronized updates to education plan data, learner characteristic information, and generative outputs within the server.

The described architecture provides technical improvements over conventional systems. The server reduces communication load by structuring data exchanges: the terminal transmits compact event-level behavior information, and the server, not the terminal, performs heavy statistical learning and generative inferencing. The server improves processing speed by caching model parameters in memory and updating only incremental portions of learner characteristic information when new behavior events arrive. The server improves accuracy by using multi-dimensional feature vectors and a trained neural network instead of simple rule-based estimators, resulting in better prediction of learner mastery and engagement. The server enhances data management by storing consistent, relationally connected structures—linking behavior events, characteristics, and plan steps—instead of loosely organized logs.

Furthermore, the combination of machine-learned learner modeling with dynamic prompt sentence generation and structured interpretation of generative outputs constitutes a non-conventional, non-generic use of computer resources, because the system transforms raw behavioral and emotional input data into tightly coordinated control information that governs the operation of the educational platform in real time.

The system also departs from a mere automation of human tutoring procedures. Human tutors typically adjust content based on intuition and ad hoc judgment. In contrast, the server applies explicit algorithms that compute numeric mastery scores, uses pre-defined thresholds to trigger plan updates, and composes prompt sentences according to formal templates that encode data-driven parameters. The generative AI model operates under these constraints to generate educational content control information that conforms to the server's structural requirements. This combination of algorithmic learner modeling, structured prompt generation, and generative control of content sequencing constitutes a technical solution that improves the functioning of the underlying computer system, resulting in faster adaptation, reduced manual configuration, and lower error rates in content personalization.

In alternative embodiments, the server may use different neural network architectures, such as transformer-based encoders for behavior sequences, or may represent learner characteristic information as probability distributions instead of point estimates. The server may employ different emotion estimation methods, such as attention-based fusion of multimodal inputs.

The generative AI model may be executed locally on the server hardware or accessed from a remote model-serving cluster. The terminal may be implemented as a handheld device, a desktop device, or any other computing device capable of network communication and user interaction. In all such variations, the server continues to acquire detailed behavior information, execute a statistical learning process, generate and regenerate prompt sentences that encode structured educational context, interact with a generative AI model, and dynamically update education plan data and educational content control information in real time, thereby implementing the claimed invention.

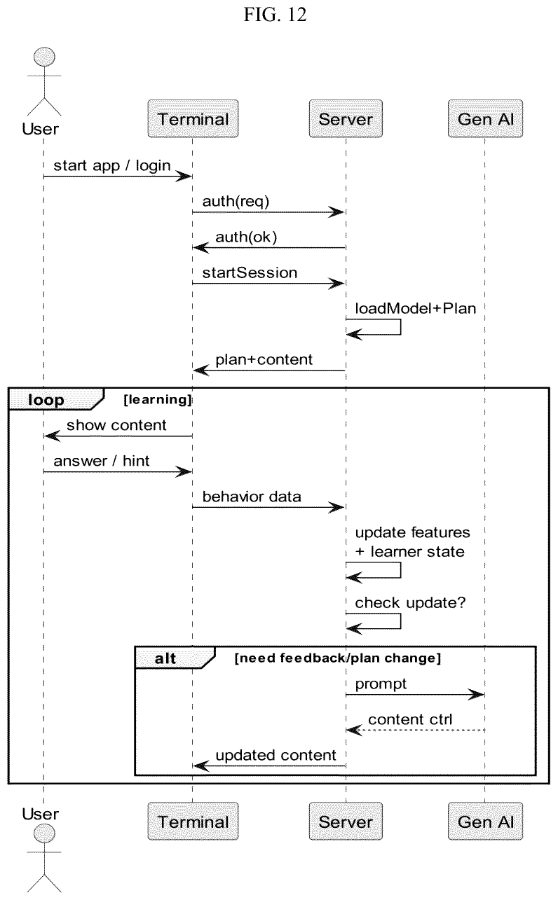

The following describes the processing flow using FIG. 12.

### Step 1:

Server initializes models and data structures.

Server loads trained parameters of a machine learning model and configuration data of a generative AI model into main memory from a storage device. The input to this step is model parameter files and configuration files stored on non-transitory media. The server allocates data structures in memory, such as tables for learner characteristic vectors, lists for education plan entries, and queues for incoming behavior events. The output of this step is an initialized runtime environment in which subsequent processing can execute without repeatedly accessing slow storage.

### Step 2:

Terminal obtains user authentication and session information.

Terminal displays a login screen and receives a user identifier and authentication credential from the user. The input to this step is user interaction data entered via a touch panel or keyboard. The terminal packages the identifier and credential into an authentication request message and transmits it to the server over a network. The output of this step is an authentication request containing structured identification data.

### Step 3:

Server authenticates the user and retrieves learner profile.

Server receives the authentication request from the terminal and verifies the credential using an authentication module and a user database. The input to this step is the request message containing the user identifier and credential. The server performs a lookup in the database, compares hashed credentials, and, if valid, retrieves a learner profile including learner ID, course enrollment, and last known education plan ID. The output of this step is an authentication response with a success/failure flag and, on success, learner profile data that is sent back to the terminal.

### Step 4:

Terminal establishes a learning session.

Terminal receives the authentication response from the server. The input to this step is the response containing the learner profile. The terminal stores the learner ID and session token in local memory and initializes a session context, including current course and last accessed content. The terminal then sends a “session start” message to the server including the learner ID and requested course. The output of this step is a session context on the terminal and a session-start request sent to the server.

### Step 5:

Server acquires existing education plan or creates a new one.

Server receives the session-start request containing the learner ID and course information.

The input to this step is the learner ID and requested course. The server queries the storage device to determine whether education plan data already exists for the learner. If existing plan data is found and is within a freshness window, the server loads it into memory; otherwise, the server marks that a new plan must be generated. The output of this step is either loaded education plan data or a flag indicating that no valid plan is available.

### Step 6:

Server acquires recent behavior information.

Server reads behavior information associated with the learner from the storage device. The input to this step is the learner ID. The server retrieves recent behavior events, including task identifiers, response results, response times, browsing history of materials, and reference history of support information. The server aggregates these events into feature-ready structures, such as sequences grouped by topic and time. The output of this step is pre-processed behavior information ready for input into a statistical learning process.

### Step 7:

Server computes learner characteristic information using a machine learning model.

Server applies a machine learning program to the behavior information. The input to this step is the aggregated behavior information from Step 6. The server converts behavior events into numerical feature vectors, normalizes response times, encodes correctness as binary or probabilistic values, and groups features by topic. The server then feeds these feature vectors into a neural network that performs matrix multiplications and non-linear activations to compute outputs representing degrees of understanding, degrees of acquisition, and learning tendencies. The output of this step is a learner characteristic vector or map that quantifies the learner's state per topic and learning dimension, which the server stores back in the storage device.

### Step 8:

Server selects candidate educational materials.

Server uses the learner characteristic information and attribute information of educational materials to filter and rank candidate materials. The input to this step is the learner characteristic vector and a catalog of educational materials with metadata such as topic, difficulty, and estimated time. The server applies selection rules, such as excluding materials above a difficulty threshold when the degree of understanding is below a certain value, and including remedial materials if error rates are high. The server computes a relevance score for each material using a weighted combination of degree of understanding mismatch, prerequisite coverage, and estimated engagement. The output of this step is a list of candidate educational material identifiers sorted by relevance.

### Step 9:

Server generates or updates education plan data.

Server constructs education plan data from the selected candidate materials. The input to this step is the sorted list of candidate materials and the learner characteristic information. The server determines a learning order by arranging materials to satisfy prerequisite constraints and to interleave review and new content. The server assigns a learning time allocation to each step using a heuristic such as increasing time for low-understanding topics and reducing time for topics with high mastery. The server organizes this into a structured plan with ordered steps and associated metadata. The output of this step is education plan data representing a concrete path of materials and timings.

### Step 10:

Server constructs a prompt sentence for the generative AI model.

Server converts structured education plan data and learner characteristic information into a natural-language description. The input to this step is the education plan data, learner characteristics, and attribute information of the candidate materials. The server generates a prompt sentence that describes the learner's mastery levels, goals, and candidate materials, and specifies the desired output format. For example, the server constructs:

“You are an AI tutoring assistant. The learner is studying differential calculus and has low mastery of the chain rule and moderate mastery of basic derivatives. The candidate contents are: (1) ‘Introductory explanation of derivatives’ (easy), (2) ‘Basic derivative practice problems’ (easy), (3) ‘Step-by-step explanation of the chain rule’ (medium), (4) ‘Chain rule practice problems’ (medium). Create a personalized learning plan for the next 60 minutes that helps the learner strengthen understanding of the chain rule. Output a structured list of steps, each with a title, a short description, and an estimated time.”

The output of this step is a prompt sentence string that encodes the current context and constraints.

### Step 11:

Server sends the prompt sentence to the generative AI model and receives educational content control information.

Server uses a generative AI client to transmit the prompt sentence to a generative AI model endpoint over a network. The input to this step is the prompt sentence and model configuration parameters such as maximum length and temperature. The generative AI model processes the tokenized prompt and generates output tokens representing educational content control information. The server receives this textual output, parses it into individual steps, and maps textual descriptions to internal fields such as step titles, explanations, and estimated times. The output of this step is structured educational content control information aligned with the education plan data.

### Step 12:

Server associates educational content control information with education plan data and stores them.

Server combines the generated educational content control information with the previously constructed education plan data. The input to this step is the structured control information from Step 11 and the education plan from Step 9. The server attaches control details, such as generated explanations and suggested procedures, to each plan step, resolves any inconsistencies (for example, mismatched time allocations), and updates identifiers linking control data to specific educational materials. The server then writes the combined structure to the storage device under the learner's record. The output of this step is a stored, ready-to-use plan with linked control information.

### Step 13:

Server delivers current education plan and control information to the terminal.

Server responds to the terminal's request for learning content. The input to this step is a request message from the terminal containing the learner ID and possibly a current step index. The server retrieves the corresponding education plan data and educational content control information from the storage device, serializes them into a response message, and sends the message to the terminal. The output of this step is a structured response containing the ordered list of materials, explanatory texts, and timing suggestions.

### Step 14:

Terminal renders learning content and control information.

Terminal receives the structured response from the server. The input to this step is the education plan and control information. The terminal decodes the response, maps material identifiers to UI components such as text views, video players, and interactive problem widgets, and displays the current step, including the generated explanations and suggested procedures, on the display unit. The terminal initializes timers for tracking response times and sets up event listeners for user actions. The output of this step is a rendered learning screen ready for user interaction.

### Step 15:

User interacts with the learning content.

User reads explanations, watches videos, and answers problems presented by the terminal.

The input to this step is the displayed content and UI controls. The user selects answer options, enters text responses, taps hint buttons, and navigates between steps. The output of this step is raw interaction data such as selected answers, timestamps of actions, hint requests, and navigation commands, which the terminal captures.

### Step 16:

Terminal generates behavior information from user interactions.

Terminal logs user interactions in local memory, associating them with the current learner ID and content identifiers. The input to this step is raw interaction events captured in Step 15.

The terminal aggregates events into behavior information objects that record task identifiers, response results, response times, browsing sequences, and support usage flags. The terminal periodically or upon certain triggers (such as completion of a problem) packages these behavior information objects into a transmission buffer and sends them to the server. The output of this step is structured behavior information transmitted over the network.

### Step 17:

Server updates behavior records and recomputes learner characteristic information.

Server receives behavior information from the terminal. The input to this step is the transmitted behavior data batch. The server appends new events to the learner's behavior history in the storage device, and updates summary statistics such as rolling averages of response times and accuracy per topic. The server then re-runs the statistical learning process using the updated behavior information: it extracts features from the new events, combines them with existing feature aggregates, and feeds them through the trained neural network.

The output of this step is updated learner characteristic information that reflects the latest learning performance.

### Step 18:

Server acquires emotion information and combines it with learner characteristic information.

Server processes multimodal input data for emotion estimation. The input to this step may include image data, acoustic data, and text input that have been transferred from the terminal.

The server applies specialized models: a convolutional neural network for facial expression classification, a voice feature analysis model for prosodic cues, and a text classifier for sentiment and frustration detection. The server fuses these outputs into emotion information, such as engagement and frustration scores. The server then updates the learner characteristic information by attaching these emotion scores as additional dimensions. The output of this step is an augmented learner characteristic vector that includes both cognitive and emotional indicators.

### Step 19:

Server decides whether to dynamically update the education plan.

Server evaluates the updated learner characteristic information and emotion information against predetermined conditions. The input to this step is the current characteristic vector and plan state. The server checks rules such as: if the degree of understanding for a topic remains below a threshold after several attempts, or if frustration exceeds a limit, then a plan update is needed. If no condition is met, the server may maintain the current plan; if a condition is met, the server marks the plan as requiring updates. The output of this step is a decision flag and, if positive, a list of topics or steps that require modification.

### Step 20:

Server constructs a revised prompt sentence for adaptive feedback or plan modification.

Server prepares a prompt sentence that reflects the new learner state and desired adaptation.

The input to this step is the augmented learner characteristic information, emotion information, and the current education plan data, including steps identified for change. The server embeds conditions into natural-language instructions, such as adjusting difficulty, changing explanation style, or inserting remedial steps. For example, the server may generate:

“The learner has solved 10 chain rule problems and answered only 3 correctly. The learner requested hints on 7 problems and took significantly longer than expected on each problem. The learner currently appears frustrated. Propose additional basic contents that review prerequisite concepts for the chain rule, such as function composition and basic differentiation rules. Use simpler language, add encouragement, and limit the total additional time to 30 minutes. Output a list of recommended steps with titles, short descriptions, and estimated time.”

The output of this step is a revised prompt sentence that explicitly encodes adaptation requirements.

### Step 21:

Server sends the revised prompt sentence to the generative AI model and obtains updated educational content control information.

Server transmits the revised prompt sentence to the generative AI model as in Step 11. The input to this step is the revised prompt sentence and model parameters. The generative AI model generates new or modified educational content control information, such as additional remedial steps, reordered content, and revised explanatory messages with supportive tone.

The server parses the returned text and converts it into updated control structures, including new step descriptors and explanation fields. The output of this step is updated educational content control information that reflects the adaptive changes.

### Step 22:

Server updates education plan data and synchronizes with the terminal.

Server modifies the existing education plan data using the updated control information. The input to this step is the current plan and the new control information from Step 21. The server inserts new steps, removes or defers existing steps, and adjusts time allocations as indicated.

The server updates references to educational materials to ensure consistency, then writes the updated plan back to the storage device. The server notifies the terminal that an updated plan is available, for example by sending a push message with a plan version identifier. The output of this step is stored updated education plan data and a notification to the terminal.

### Step 23:

Terminal retrieves and displays updated content to the user.

Terminal receives the notification or periodically checks for updated plan versions. The input to this step is the plan version identifier and learner ID. The terminal requests the updated plan from the server, receives the revised education plan data and educational content control information, and re-renders the learning interface accordingly. The terminal may update the current lesson view, show new remedial content, and present revised explanations and supportive messages. The output of this step is an updated display on the terminal that reflects the real-time adaptation driven by the server's processing.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented education support systems typically rely on fixed rule sets or static recommendation logic executed by a processor to select learning content for a learner. In such systems, learner data such as scores and completion status is often used only for simple threshold-based branching or ranking, and is not transformed into a rich, machine-interpretable representation that can be effectively consumed by a generative artificial intelligence model. As a result, even when a generative artificial intelligence model is invoked, the input is ad hoc and unstructured, leading to non-deterministic, difficult-to-control outputs and unstable education plans.

Further, in conventional systems, prompt sentences to be supplied to a generative artificial intelligence model are usually handcrafted and remain static regardless of changes in the learner's comprehension, progress, or feedback. The processor does not systematically compute comprehension indices and progress indices per learning task, nor does it automatically encode such indices, along with subjective feedback, into dynamically generated prompt sentences. This limitation causes inefficient use of computing resources and produces education plans that are not robustly tailored to evolving learner states.

Moreover, conventional systems lack mechanisms by which the processor verifies and normalizes the output format of the generative artificial intelligence model. The generated text may vary in structure, style, and completeness, requiring manual post-processing or complex ad hoc parsing logic. This variability complicates automatic extraction of structured education plan information, such as learning tasks, learning order, learning materials, and difficulty levels. As a result, it is difficult to implement reliable, large-scale systems in which a processor can repeatedly invoke a generative artificial intelligence model and integrate the outputs into a database-backed, version-managed curriculum.

Additionally, conventional systems do not provide an integrated feedback loop in which learning result information and feedback information, including detailed answer history, learning time, operation history, and subjective evaluation, are continuously converted into updated comprehension indices and progress indices, which in turn drive re-generation of prompt sentences and dynamic modification of education plans. Without such a closed-loop control implemented at the processor level, the system cannot efficiently adapt its behavior over time, and cannot fully exploit the capabilities of generative artificial intelligence models in a controlled and auditable manner.

Accordingly, there is a need for a computer-implemented system and method in which a processor systematically (i) computes and maintains task-level comprehension and progress indices from heterogeneous learner data, (ii) generates structured, constraint-rich prompt sentences for a generative artificial intelligence model, (iii) enforces output formatting and structure on the responses of the generative artificial intelligence model, and (iv) dynamically updates individualized education plans in response to both objective performance metrics and subjective feedback, while maintaining version control of such plans. Such a system would improve the operation of the computer itself by enabling more efficient data processing, more predictable interaction with generative artificial intelligence models, and more reliable automation of education plan generation and update.

The specific processing by the specific processing unit 290 of the data processing device 12 in Example 2 is realized by the following means.

The present invention provides a server comprising a processor and a storage device, the processor being configured to acquire, from the storage device, learning record information and behavior history information for a learning subject, perform numerical computation processing and information aggregation processing to calculate a comprehension index and a progress index for each learning task, generate, based on the comprehension index and the progress index, a summary sentence describing characteristics and a learning state of the learning subject, construct a prompt sentence including the summary sentence and generate generation instruction information to be supplied to a generative artificial intelligence model, input the prompt sentence to the generative artificial intelligence model, extract, from natural language text output by the generative artificial intelligence model, structured education plan information including items relating to learning tasks, learning order, learning materials, and difficulty level, and generate an individualized education plan for each learning subject by using the structured education plan information, receive learning result information and feedback information from a terminal device, recalculate the comprehension index and the progress index so as to reflect the learning result information and the feedback information, compare the recalculated indices with threshold information to determine whether the learning subject is to advance to a next learning task or repeat a same learning task, update the individualized education plan dynamically by regenerating the education plan based on outputs of the generative artificial intelligence model in response to first and second prompt sentences that respectively cause inclusion of new learning domains for tasks permitted to advance and inclusion of additional problem information and explanation information for tasks requiring relearning, determine whether the natural language text obtained from the generative artificial intelligence model conforms to a predetermined format or data structure, and when the natural language text does not conform to the predetermined format or data structure, automatically generate an additional prompt sentence requesting format correction or structured output, re-input the additional prompt sentence to the generative artificial intelligence model, and manage versions of the education plan information per learning subject in the storage device based on corrected outputs of the generative artificial intelligence model. This enables the server to improve computer operation by automatically transforming heterogeneous learner data into stable, constraint-rich prompt sentences, enforcing structured outputs from the generative artificial intelligence model, and executing a closed-loop, version-managed update process for individualized education plans, thereby providing more predictable, efficient, and scalable control over generative artificial intelligence-based curriculum generation.

The term “learning subject” refers to a human learner for whom learning record information, behavior history information, comprehension indices, progress indices, and individualized education plans are generated, stored, analyzed, and updated by the system.

The term “learning record information” refers to data representing a learning subject's past learning activities, including at least test scores, task completion status, and topic-wise performance results, which are stored in a storage device and processed by the processor.

The term “behavior history information” refers to data representing a learning subject's interactions with a terminal device or learning environment, including at least answer history, operation logs, and time spent on learning tasks, which are used to derive comprehension and progress indices.

The term “storage device” refers to any computer-readable recording medium, including at least non-volatile memory, volatile memory, and external storage, that stores learning record information, behavior history information, threshold information, and education plan information for access by the processor.

The term “comprehension index” refers to a numerical or categorical value calculated by the processor, based on learning record information and behavior history information, that represents a degree of understanding of a particular learning task by a learning subject.

The term “progress index” refers to a numerical or categorical value calculated by the processor, based on learning record information and behavior history information, that represents a degree of advancement or completion of a particular learning task or sequence of learning tasks by a learning subject.

The term “learning task” refers to a unit of learning activity, including at least a topic, lesson, exercise set, or assessment item, that can be individually tracked, evaluated, and scheduled within an education plan.

The term “information aggregation processing” refers to processing performed by the processor to group, summarize, and statistically analyze learning record information and behavior history information, including at least computing averages, counts, distributions, and time-based aggregates.

The term “numerical computation processing” refers to processing performed by the processor to perform arithmetic, statistical, or algorithmic calculations on numerical data derived from learning record information and behavior history information, including at least scaling, weighting, and combining values to compute indices.

The term “summary sentence” refers to a natural-language expression automatically generated by the processor that concisely describes a learning subject's characteristics and learning state, including at least comprehension indices, progress indices, and notable behavior patterns.

The term “prompt sentence” refers to a natural-language instruction or query, constructed by the processor, that includes at least the summary sentence and is input to a generative artificial intelligence model in order to cause the generative artificial intelligence model to generate an output related to an education plan.

The term “generation instruction information” refers to data prepared by the processor that specifies a prompt sentence, parameters, and any constraints to be provided to a generative artificial intelligence model in order to control generation of natural-language text related to an education plan.

The term “generative artificial intelligence model” refers to a computer-implemented model that generates natural-language text in response to input data, including at least a neural network language model executed on a computing resource accessible by the processor.

The term “natural language text” refers to character data representing words and sentences in a human language, generated by the generative artificial intelligence model and processed by the processor.

The term “education plan information” refers to structured data representing an arrangement of learning tasks for a learning subject, including at least task identifiers, learning order, associated learning materials, and difficulty levels.

The term “individualized education plan” refers to an education plan that has been generated or updated by the processor so as to be tailored to a particular learning subject based on that subject's comprehension index, progress index, learning record information, and feedback information.

The term “learning order” refers to data defining a sequence or precedence relationship among a plurality of learning tasks, indicating in which order a learning subject is to perform the learning tasks.

The term “learning materials” refers to digital content associated with a learning task, including at least problem statements, instructional text, multimedia content, and explanation text, that is presented to a learning subject by a terminal device.

The term “difficulty level” refers to data indicating a relative level of challenge of a learning task or learning material, determined by the processor or included in the education plan information.

The term “terminal device” refers to any computing apparatus operated by or on behalf of a learning subject, including at least a personal computer, tablet device, or smartphone, that transmits learning result information and feedback information to the server and displays education plan information.

The term “learning result information” refers to data received from a terminal device that indicates outcomes of a learning subject's activities, including at least correctness of answers, scores, completion status, and time spent, which is used by the processor to recalculate indices.

The term “feedback information” refers to data received from a terminal device that represents subjective or qualitative input from a learning subject or a user, including at least textual comments, difficulty ratings, and satisfaction ratings.

The term “answer history information” refers to a subset of learning result information representing which answers were selected or input by a learning subject for specific questions or tasks, and whether the answers were correct or incorrect.

The term “learning time information” refers to a subset of learning result information representing time durations associated with learning tasks, including at least start times, end times, and accumulated study times.

The term “operation history information” refers to a subset of behavior history information representing interaction events on a terminal device, including at least button presses, screen transitions, and navigation actions.

The term “subjective evaluation information” refers to a subset of feedback information that reflects a learning subject's or user's perceived difficulty, clarity, satisfaction, or other subjective assessment of learning tasks or materials.

The term “threshold information” refers to reference values stored in the storage device and used by the processor to compare against comprehension indices and progress indices in order to determine whether to advance a learning subject to a next learning task or to repeat a same learning task.

The term “new learning domain” refers to a learning topic or category that is different from and subsequent to a current learning task, to which a learning subject may be advanced when the comprehension index and progress index satisfy predetermined conditions.

The term “additional problem information” refers to data defining further exercises, questions, or practice items for a learning task that has not yet reached a target comprehension level, to be added to an individualized education plan.

The term “explanation information” refers to data representing explanatory text, hints, examples, or other instructional content associated with a learning task, which is provided to a learning subject in order to support understanding.

The term “predetermined format” refers to a specification of structural or syntactic rules for natural language text or structured output from the generative artificial intelligence model, including at least required sections, labels, or delimiters.

The term “data structure” refers to an arrangement and organization of data elements, including at least fields, keys, and nested elements, that the processor uses to represent education plan information in a machine-readable form.

The term “format correction” refers to processing in which the generative artificial intelligence model is caused, by an additional prompt sentence, to regenerate its output so as to conform to the predetermined format or data structure required by the processor.

The term “structured output” refers to natural language text or data generated by the generative artificial intelligence model that conforms to a specified format or data structure, enabling direct parsing and extraction of fields by the processor.

The term “additional prompt sentence” refers to a prompt sentence automatically generated by the processor when an output of the generative artificial intelligence model does not conform to a predetermined format or data structure, the additional prompt sentence instructing the generative artificial intelligence model to correct the format or produce structured output.

The term “version management” refers to processing by which the processor assigns identifiers, timestamps, and relationships to successive instances of education plan information for a learning subject, and maintains a history of changes in the storage device.

The term “communication line” refers to any wired or wireless communication medium and associated protocols by which the server and the terminal device exchange data, including at least packet-switched networks.

The server implements the invention by executing a program on one or more processors and cooperating with at least one terminal and at least one storage device connected through a communication network. The server operates on general-purpose computing hardware, such as an x86_64 central processing unit and, in some embodiments, a graphics processing unit for accelerating matrix operations. The server uses a database management program, such as a relational database engine, and an application execution environment, such as a web application framework. The server further uses a machine learning library, such as a numerical computation library and a neural network library, to implement a generative AI model and associated data processing.

The server stores learning record information and behavior history information for each learning subject in the storage device. The server defines these data in specific data structures. For example, the server stores learning record information in a table that includes, as fields, a subject identifier, a task identifier, a timestamp, a raw score, a maximum score, and a completion flag. The server stores behavior history information in a table that includes, as fields, a subject identifier, an operation type, a screen identifier, an event timestamp, and a duration value. The server uses an index structure in the database to enable fast retrieval of these records by subject identifier and by task identifier.

The server executes numerical computation processing and information aggregation processing on the retrieved data. The server uses a data processing library, such as a tabular data analysis module, to load records into in-memory data structures, for example arrays or data frames. The server calculates a comprehension index for each learning task by computing at least a weighted average of normalized scores, where more recent scores are assigned higher weights. The server also calculates a progress index by computing ratios of completed tasks to assigned tasks and by analyzing time spent relative to planned durations.

The server stores these indices in a dedicated index table, where each row includes a subject identifier, a task identifier, a comprehension index value, a progress index value, and a last-update timestamp.

The server generates a summary sentence for each learning subject by converting the comprehension indices, progress indices, and selected elements of behavior history into natural language. The server uses a rule-based template engine to map internal fields to text segments. For example, the server inserts a task identifier, a comprehension index value, and a progress index value into sentence templates such as “For task [TASK_NAME], the average score is [VALUE] and the understanding index is [VALUE].” The server concatenates multiple such sentences into a summary sentence that describes the learning subject's state in a structured but natural form.

The server constructs a prompt sentence to be input to the generative AI model by embedding the summary sentence and additional constraints into a larger natural-language instruction.

The server stores the prompt sentence in a prompt log table and also assembles generation instruction information that specifies parameters such as maximum output length, output style, and desired structure. The server then transmits the prompt sentence to the generative AI model through an application programming interface. In one embodiment, the server uses a transformer-based neural network architecture as the generative AI model. The model has multiple self-attention layers, feedforward layers, and layer normalization, and has been trained using a large corpus of text, including educational content, with a cross-entropy loss function and gradient-based weight updates such as the Adam optimizer.

The server configures the generative AI model to generate natural language text in response to the prompt sentence. Inside the model, input tokens of the prompt sentence are embedded as vectors; the attention mechanism computes attention weights over previous tokens using scaled dot products; and the model propagates information through multiple layers to produce a probability distribution over output tokens. The server sets generation parameters to control determinism and diversity, for example using temperature and top-k or nucleus sampling parameters, and thereby adjusts the level of variability in the generated education plan. The server receives the generated natural language text from the model and records it in association with the corresponding prompt sentence.

The server parses the model output to extract education plan information in a structured form.

In one embodiment, the server constrains the model to output labeled sections, such as “Next Topic:”, “Objectives:”, and “Practice Problems:”. The server applies pattern matching and parsing rules to identify these sections and to map them into internal data structures such as objects or records containing a task identifier, an objective description, a content type, a difficulty level, and an ordering index. In an alternative embodiment, the server instructs the generative AI model, through a prompt sentence, to generate output in a constrained pseudo-structured format that uses consistent markers and delimiters, making parsing more robust and efficient.

The terminal operates as a client device that displays the individualized education plan generated by the server. The terminal uses its display hardware and a user interface library to render lists of learning tasks, explanatory texts, and links or buttons to launch specific learning materials. The terminal maintains local state regarding which tasks have been started, paused, or completed. The terminal captures user interactions, including time spent on each task, input answers for questions, and navigation patterns. The terminal stores these interactions in local buffers and periodically sends learning result information and feedback information to the server using a network communication stack, such as a transport protocol over a secure channel.

The user views the education plan on the terminal and interacts with the displayed content.

The user selects the next recommended learning task, reads or watches the associated learning materials, and answers questions presented by the terminal. The user optionally inputs subjective feedback, such as difficulty ratings or free-text comments, through user interface controls. The terminal encodes this feedback as text and numeric values, associates it with the task identifier and subject identifier, and transmits it to the server as feedback information.

The server receives the learning result information and feedback information from the terminal and merges these data into the stored learning record information and behavior history information. The server updates answer history tables with new entries, updates learning time tables with newly calculated durations, and records operation history events.

The server also stores subjective evaluation information in a separate table that links textual comments and ratings to specific tasks and time points. The server then recalculates comprehension indices and progress indices using the updated data and compares these indices to threshold information stored in the storage device.

The server maintains threshold values for advancement and for remediation. For each learning task, the server compares the comprehension index and progress index with predetermined thresholds. When both indices exceed corresponding thresholds, the server marks the task as mastered and selects a next learning task from a dependency graph or curriculum graph stored in the storage device. When one or both indices fall below the thresholds, the server marks the task as needing review and triggers the generation of additional practice content.

The server generates differentiated prompt sentences depending on the determination. For advancement, the server constructs a prompt sentence that includes statements such as:

“Learner A has the following data:
Fractions: average score 92, understanding index 90, total study time 180 minutes.
Decimals: no attempts yet.

Recent feedback: ‘fractions are easy now.’

Using this data, generate the next learning step and an individualized education plan for the next three sessions.”

For remediation, the server constructs a prompt sentence such as:

“Learner B has an understanding index of 55 for fractions and specific difficulty with simplifying fractions. Please generate 10 additional practice problems and step-by-step explanations focused on simplifying fractions, and do not advance to decimal calculations yet.”

The server may also embed subjective evaluation information in the prompt sentence to supply constraint conditions, for example:

“Learner C has an understanding index of 65 for decimal calculations.

Objective data: average score 60 on recent decimal tests, average study time 25 minutes per session.

Subjective feedback: ‘decimals are confusing, especially when adding numbers with different decimal places.’

Using this data, adjust the education plan and propose the next learning step, focusing on easier examples and clearer explanations.”

The server uses these specific prompt sentences to cause the generative AI model to produce outputs that are constrained and aligned with system-defined advancement rules rather than arbitrary free-form text. This non-conventional interaction pattern between the server and the generative AI model improves the predictability and technical utility of the generated output and reduces the need for error-prone manual curation.

The server further implements format validation and correction for outputs of the generative AI model. The server defines a predetermined format or data structure for acceptable model outputs, including required headings, item separators, and field labels. The server checks the received natural language text against this format by scanning for required markers and by counting and validating segments. When the server detects non-conformance, the server automatically generates an additional prompt sentence that instructs the generative AI model to re-output the same content in a corrected structure. For instance, the server may generate a prompt sentence such as:

“Reformat the previous education plan so that it includes clear sections with the following labels: ‘Next Topic:’, ‘Objectives:’, ‘Learning Materials:’, and ‘Practice Problems:’, and list items under each label as separate lines.”

The server sends this additional prompt sentence along with relevant context to the generative AI model, receives a reformatted output, and then parses it reliably into education plan information structures. This loop, where the server dynamically enforces output formats through prompt sentences, constitutes a technical solution for controlling a generative model that is inherently probabilistic and free-form.

The server performs version management of the education plan information. The server assigns a version identifier to each generated plan and stores a history of versions for each learning subject in the storage device. The server stores metadata such as generation time, source prompt sentence identifier, model configuration parameters, and applied threshold values. The server allows retrieval of previous versions when needed, for example to compare effectiveness of different plans or to restore a prior curriculum version. This structured version management improves data integrity and auditability and enables analysis of system performance over time.

The server, by implementing the described data structures, aggregation algorithms, index calculations, and prompt construction mechanisms, improves operation of the computer system in several ways. First, the server reduces computational waste by calculating compact comprehension indices and progress indices, so that the generative AI model does not need to process raw, high-volume behavior logs directly. Second, the server improves parsing efficiency and reduces error rates by constraining and validating the format of model outputs, thereby converting inherently unstructured text into reliably structured data that can be directly stored and queried. Third, the server supports scalable multi-user operation by managing education plans and related indices in a relational database with indexes, enabling fast queries and updates even as the number of learning subjects increases.

The server uses non-conventional processing steps in its interaction with the generative AI model. Instead of merely substituting a human author with an automated text generator, the server transforms learner data into a structured semantic representation, encodes explicit advancement rules and thresholds into prompt sentences, and uses additional prompt sentences to enforce structural constraints on outputs. These steps are not equivalent to manual curriculum design and are not merely automating human judgment. Rather, the server is modifying and controlling the internal operation of the generative AI model, including its decoding behavior and output structure, to achieve technical effects: reproducibility, improved parseability, and reduced resource consumption for downstream processing.

The server, in some embodiments, implements different generative AI models or different configurations for different types of tasks. The server may use a smaller model for short, structured outputs and a larger model for complex, multi-step plans. The server may apply quantization or pruning to deployed models to reduce memory and bandwidth requirements while maintaining required accuracy for curriculum generation. The server can adjust loss functions and learning rates during model training to optimize for clarity and structure of outputs rather than only semantic content. These variations demonstrate that the invention is not limited to one particular neural network implementation, but covers a family of implementations that share the described control and integration mechanisms.

The terminal and the server together implement an end-to-end loop in which technical improvements accrue from data flow and control flow decisions. The terminal formats and compresses logs before transmission, reducing communication load. The server aggregates data into indices and summary sentences, reducing the token length and complexity of prompt sentences, which lowers inference computing cost on the generative AI model side.

The server's enforcement of structured output decreases the need for post-processing heuristics, which further reduces processor cycles. These combined effects illustrate that the invention achieves hardware-level benefits in performance, efficiency, and reliability.

The user, by interacting with the terminal, indirectly contributes new data that the server uses to further refine indices and plan generation. However, the core technical contributions lie in how the server processes, aggregates, and controls this data and how the server communicates with and constrains the generative AI model. The server's operations and data structures, as described, allow another person skilled in the art to implement the invention using known computing hardware and software libraries, while clearly understanding how to construct, store, and process prompt sentences, indices, and education plan information to realize the claimed technical effects.

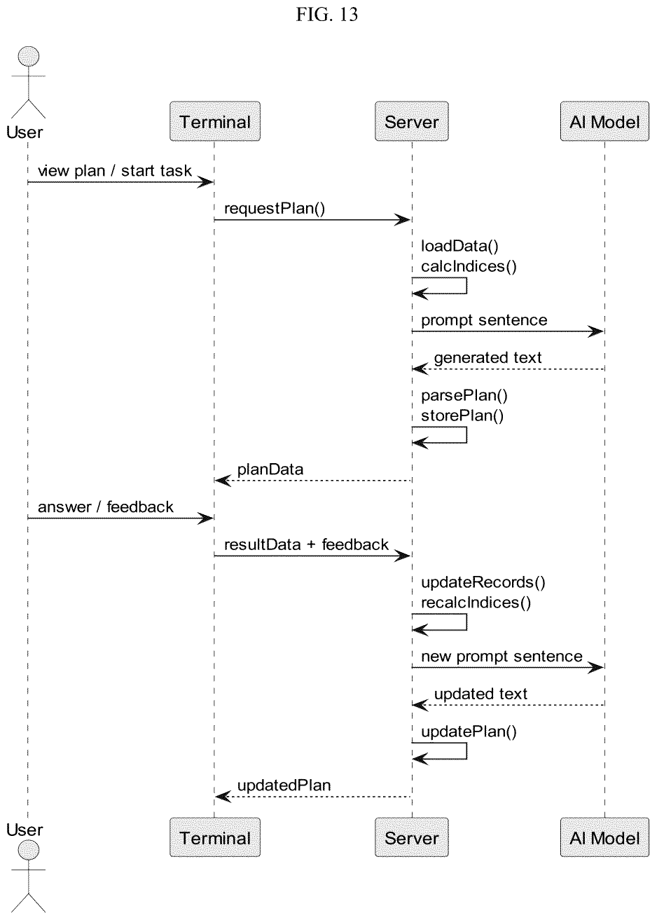

The following describes the processing flow using FIG. 13.

### Step 1:

Server acquires learning record information and behavior history information from the storage device.

Server receives, as input, a subject identifier from an internal scheduler or from a request sent by the terminal. Based on this subject identifier, server issues database queries to retrieve learning record information (including task identifiers, scores, completion flags, and timestamps) and behavior history information (including answer events, operation logs, and time durations). Server loads the retrieved rows into in-memory data structures such as arrays or tables. Server performs basic validation and filtering, for example removing corrupted records and sorting entries by timestamp. As an output, server produces a normalized internal dataset for the subject, where each record is aligned by task identifier and time, ready for computation of indices.

### Step 2:

Server calculates comprehension indices and progress indices for each learning task.

Server takes, as input, the normalized dataset produced in Step 1. For each learning task, server applies numerical computation processing: server normalizes raw scores to a 0-100 scale, calculates a weighted average where recent scores have higher weights, and aggregates error counts and correct-answer ratios. Server also computes progress indices by dividing the number of completed items by the total assigned items and by comparing actual learning time with planned time. Server uses arithmetic operations, weighted sums, and basic statistics to generate these values. As an output, server generates an index table in memory, where each row contains a task identifier, a comprehension index, a progress index, and summary statistics, and stores or updates these values in an index table in the storage device.

### Step 3:

Server generates a summary sentence describing the learning subject's state.

Server takes, as input, the index table and selected pieces of learning record information such as topic names and recent performance trends. Server passes these values into pre-defined text templates, for example inserting task names and index values into sentence patterns like “For topic fractions, the average score is 92 and the understanding index is 90.” Server concatenates such sentences for all relevant tasks and may add phrases indicating overall progress, such as “Overall, the learner is ahead of the planned schedule.” Server thus performs string formatting and concatenation operations. As an output, server produces a summary sentence representing the learning subject's state in natural language.

### Step 4:

Server constructs a prompt sentence and generation instruction information for the generative AI model.

Server takes, as input, the summary sentence, threshold values, and any stored curriculum rules. Server embeds the summary sentence into a larger natural-language instruction that specifies desired behavior of the generative AI model, such as “Using this data, generate the next learning step and an individualized education plan for the next three sessions.” Server appends constraints regarding progression (“do not advance to decimals if fractions are not mastered”) and output structure (“include sections: Next Topic, Objectives, Learning Materials, Practice Problems”). Server also prepares generation instruction information including parameters such as maximum number of tokens, temperature, and allowed output length. As an output, server generates a prompt sentence and an associated configuration object ready to be supplied to the generative AI model.

### Step 5:

Server sends the prompt sentence to the generative AI model and obtains generated text.

Server uses, as input, the prompt sentence and the generation instruction information produced in Step 4. Server encodes the prompt sentence into token IDs using a tokenizer associated with the transformer-based generative AI model. Server sends these token IDs and the generation parameters through an application programming interface to the model execution environment. Inside the model, embedded vectors, self-attention layers, and feedforward layers compute probability distributions over next tokens; server waits for the decoding process to generate a sequence of output tokens according to the specified parameters. Server then decodes the output tokens back into human-readable natural language text. As an output, server obtains a text block that describes a proposed education plan, including suggested topics, ordering, materials, and exercises.

### Step 6:

Server validates the format of the generated text and, if necessary, requests a structured re-output.

Server uses, as input, the generated text from Step 5 and a predetermined format specification that defines required headings and labels. Server scans the text to check whether required labels such as “Next Topic:”, “Objectives:”, “Learning Materials:”, and “Practice Problems:” are present and whether entries under each label follow expected patterns. If server detects non-conformance (for example, missing headings or ambiguous structure), server constructs an additional prompt sentence that refers to the previous output and explicitly requests a reformatted, structured version. Server sends this additional prompt sentence to the generative AI model, receives a corrected output, and repeats validation until the text conforms or a maximum number of attempts is reached. As an output, server produces a validated, well-structured natural language representation of the education plan.

### Step 7:

Server parses structured text into education plan information.

Server takes, as input, the validated structured text from Step 6. Server applies parsing rules and pattern-matching functions to locate section labels and to split the text into discrete plan items. For each item, server extracts a task name, an objective description, a content type (for example, explanation or exercise), and a difficulty indication if present. Server maps these extracted fields into internal data structures such as records or objects, and assigns ordering indices according to the sequence in the structured text. As an output, server generates structured education plan information, for example a list or table of plan entries, and stores this information in the storage device associated with the corresponding subject identifier and a new version identifier.

### Step 8:

Server determines advancement or remediation based on updated indices and threshold information.

Server uses, as input, the comprehension indices and progress indices from Step 2 and threshold information retrieved from the storage device. For each learning task, server compares the indices with corresponding threshold values using conditional logic. When both indices exceed thresholds, server marks the task as a candidate for advancement; when one or both are below thresholds, server marks the task as requiring remediation. Server then selects a next learning task from a stored curriculum graph if advancement is allowed, or designates the same task for review if remediation is necessary. As an output, server generates a decision table that indicates, per task, whether to progress to a new topic or remain on a current topic and what kind of content (new or supplemental) is needed.

### Step 9:

Server regenerates or adjusts the education plan based on advancement or remediation decisions.

Server takes, as input, the decision table from Step 8 and the existing structured education plan information from Step 7. For tasks marked for advancement, server may construct new prompt sentences that request plans including new learning domains (for example, “Now advance to decimal calculations”) and call the generative AI model again to append or replace sections of the plan. For tasks requiring remediation, server constructs prompt sentences emphasizing weaknesses and requesting additional practice and explanations (for example, “Please generate 10 additional practice problems and step-by-step explanations focused on simplifying fractions”). Server invokes the generative AI model, validates and parses the outputs as in previous steps, and merges new plan entries into the existing plan. As an output, server produces an updated individualized education plan that reflects progression or remediation and stores it as a new version in the storage device.

### Step 10:

Server transmits the individualized education plan to the terminal.

Server uses, as input, the latest version of the education plan information for a subject. Server serializes this plan into a structured representation such as a list of tasks with associated descriptions, objectives, and identifiers, and wraps it into a response message. Server sends this response via a communication interface over a network to the terminal identified by a session or device identifier. As an output, server delivers the current education plan to the terminal for display and interaction.

### Step 11:

Terminal receives and displays the education plan to the user.

Terminal takes, as input, the response message received from the server that contains the structured education plan. Terminal parses the message using its built-in data handling libraries, constructs user interface elements such as lists, buttons, and detail views, and maps each plan entry to a visual component. Terminal orders and groups entries according to the sequence and difficulty levels specified by the server. As an output, terminal renders on its display a screen showing next topics, objectives, learning materials, and practice problems, allowing the user to select and start each learning task.

### Step 12:

User executes learning tasks and provides implicit and explicit feedback.

User takes, as input, the displayed education plan on the terminal. User selects a recommended learning task, reads or watches the presented materials, and answers questions or solves exercises. User's input, such as selected answers, keyboard entries, and navigation actions, generates implicit performance data. User may also enter explicit feedback, such as rating the difficulty or typing comments like “fractions are still difficult” or “decimals are easy now.” As an output, user generates raw interaction data and feedback data that the terminal records as learning result information and feedback information.

### Step 13:

Terminal records and aggregates learning result information and feedback information.

Terminal uses, as input, the user's interactions and feedback during execution of learning tasks. Terminal records timestamps for starting and finishing tasks, logs each answer with correctness, and stores navigation and operation events. Terminal also captures explicit ratings and free-text comments. Terminal aggregates this data locally, for example by computing total time per task and summarizing counts of correct and incorrect answers. As an output, terminal generates compact learning result information (including scores, durations, and completion flags) and feedback information (including subjective evaluation) and packages them into a structured message to send to the server.

### Step 14:

Terminal transmits aggregated data to the server for further processing.

Terminal takes, as input, the structured learning result information and feedback information generated in Step 13. Terminal establishes or uses an existing network connection with the server, encodes the data into a request message, and sends it over a secure communication channel. Terminal may batch multiple records to reduce communication overhead. As an output, terminal delivers the latest learning result information and feedback information for the subject to the server.

### Step 15:

Server updates stored data and closes the loop for subsequent iterations.

Server uses, as input, the learning result information and feedback information received from the terminal in Step 14. Server inserts new entries into learning record tables, updates behavior history and answer history records, and appends subjective evaluation information to dedicated feedback tables. Server then schedules or immediately performs recalculation of comprehension indices and progress indices as described in Step 2, using the newly added data. As an output, server updates internal indices and stored records, thereby preparing the system for a next cycle of prompt sentence generation, generative AI model invocation, and education plan update.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented education support systems typically rely on static rule-based logic or fixed recommendation heuristics to select and present learning content. Such systems are often configured to retrieve learning history from a storage apparatus and to display pre-defined learning materials based on coarse-grained progress metrics, such as completion rates or test averages. However, these systems are not architected to continuously reconfigure internal content-selection pipelines or representation structures in response to fine-grained learner behavior and emotional signals, and therefore cannot fully exploit modern machine learning capabilities, including generative models, to improve system-level performance.

In particular, existing systems generally suffer from the following technical issues:

### (1) Fragmented Use of Learner Data:

Even when behavior logs, performance data, and sensor data are collected, conventional systems tend to process these data streams in isolation or in batch mode. The internal data structures and control logic of the system are not designed to integrate heterogeneous data (e.g., operation histories, emotional states, and progress indicators) into a unified, machine-readable representation suitable for dynamic computation. As a result, the processor cannot efficiently generate and update machine-usable plans or control signals for downstream modules in real time.

### (2) Limited Adaptability of Content Generation Pipelines:

Traditional recommendation engines are often limited to selecting from a finite set of content items using predetermined ranking rules. They are not configured to construct prompt sentences as structured control signals for a generative AI model, nor to interpret and integrate generated outputs as structured plan data. This leads to rigid content delivery pipelines that cannot dynamically adapt internal execution flows or data structures in response to evolving learner states.

### (3) Inefficient Handling of Real-Time Emotion and Interaction Data:

Many systems do not provide an integrated processing pipeline for acquiring, analyzing, and exploiting emotion-related data (e.g., face images, audio, and text input) at the system level. Even when emotion recognition modules exist, their outputs are typically used only for superficial UI changes (such as displaying a different message), rather than as core inputs to the data structures and algorithms that control education plan generation and update.

Consequently, the system fails to optimize computation paths and content generation based on real-time emotional feedback.

### (4) Lack of Dynamic Reconfiguration of Education Plans at the System Layer:

Conventional architectures are not configured to treat education plans and content definitions as dynamically updated structured data objects that directly drive control information for terminal devices. They therefore cannot implement a closed feedback loop in which learner understanding degree, progress, and emotional state are fused, translated into prompt sentences, processed by a generative AI model, and then reintegrated as updated structured plans that modify subsequent computation and rendering on the terminal.

Thus, there is a need for an improved computer-implemented system whose processor is specifically configured to (i) integrate multi-modal learner data into characteristic information, understanding-degree information, progress information, and emotional state information, (ii) generate prompt sentences as intermediate control representations for a generative AI model, (iii) manage outputs from the generative AI model as structured education plan information and content information, and (iv) dynamically update these structures and associated control information for terminal devices in real time. Such a system would improve the internal operation of the computer by enabling more efficient and adaptive data processing pipelines, better utilization of computational resources, and more responsive control of content rendering based on fine-grained learner states.

The specific processing by the specific processing unit 290 of the data processing device 12 in Application Example 2 is realized by the following means.

The present invention provides a server comprising a processor configured to acquire learning history information and behavior history information of a learning subject from an information storage apparatus, analyze the learning history information and the behavior history information by machine learning processing to generate characteristic information of the learning subject, generate, on the basis of the characteristic information and progress information of the learning subject, a prompt sentence in a natural language including the characteristic information and the progress information, and transmit the prompt sentence as an input to a generative information processing model so as to cause the generative information processing model to generate at least one of individualized education plan information and education content information, store the education plan information and the education content information output from the generative information processing model as structured data, and manage identifiers, reference information, or generated content of educational content in association with the structured data, acquire, in real time or at predetermined time intervals, learning operation history information, answer result information, viewing time information, and interaction information of the learning subject transmitted from a terminal device, and monitor understanding degree information and learning progress information of the learning subject by evaluating an achievement status with respect to the education plan information, generate an update prompt sentence in a natural language for updating at least a part of the education plan information when at least a predetermined condition based on at least one of the emotional state information, the understanding degree information, and the learning progress information is satisfied, re-input the update prompt sentence to the generative information processing model so as to cause the generative information processing model to dynamically generate updated education plan information and updated education content information, and transmit the updated education plan information and the updated education content information to the terminal device, and generate control information for configuring at least one of a display screen, a task presentation screen, a video playback screen, and a virtual space display screen in the terminal device on the basis of the education plan information and the education content information, and provide the control information to the terminal device. This enables the computer system to internally represent learner state as structured data, to use prompt sentences as machine-interpretable control signals for the generative AI model, and to dynamically reconfigure education plans and terminal-side rendering behavior in response to real-time learning performance and emotional feedback, thereby improving adaptability, processing efficiency, and overall performance of the computer-implemented education support system.

The term “learning subject” refers to an individual who receives learning content or training through the system and whose behavior, performance, and emotional state are analyzed for generating and updating education plans.

The term “learning history information” refers to data indicating past learning activities of the learning subject, including, for example, completed tasks, test scores, accessed materials, timestamps, and other records stored in an information storage apparatus.

The term “behavior history information” refers to data indicating operational behavior of the learning subject when interacting with a terminal device, including, for example, input operations, navigation paths, response times, and interaction patterns.

The term “information storage apparatus” refers to a data storage component, such as a database system or memory device, that stores learning history information, behavior history information, education plan information, education content information, or other related information.

The term “machine learning processing” refers to computational processing that applies a statistical or learning algorithm to input data to infer patterns or models, including, for example, clustering, classification, or regression, executed by the processor.

The term “characteristic information” refers to information indicating one or more characteristics of the learning subject derived from learning history information and behavior history information, such as strengths, weaknesses, preferences, learning speed, or typical error patterns.

The term “progress information” refers to information indicating a current progress state of the learning subject with respect to an education plan, including, for example, completed items, remaining items, and time usage.

The term “prompt sentence” refers to a text string in a natural language that encodes characteristic information, progress information, emotional state information, or other context, which is provided as an input control signal to a generative information processing model.

The term “generative information processing model” refers to a computational model that generates text or other data as output in response to a prompt sentence or other input, based on learned parameters obtained through a learning process.

The term “education plan information” refers to structured information describing one or more learning tasks, topics, sequences, or schedules to be presented to the learning subject.

The term “education content information” refers to structured information that identifies or describes learning content items, such as explanations, problems, hints, video segments, documents, or interactive content.

The term “structured data” refers to data arranged in a predetermined format or schema, such as records, fields, or key-value pairs, that allow consistent storage, retrieval, and processing by the system.

The term “identifier” refers to data, such as an ID or code, that uniquely or specifically identifies an education plan, content item, or other object managed by the system.

The term “reference information” refers to data, such as a link, path, or address, that allows the system or a terminal device to access or retrieve a corresponding education content item.

The term “learning operation history information” refers to data indicating operations performed by the learning subject during execution of learning tasks, such as task start and end times, button presses, or navigation events.

The term “answer result information” refers to data indicating results of responses made by the learning subject to questions or tasks, including correctness, chosen options, and scoring.

The term “viewing time information” refers to data indicating how long the learning subject views or interacts with a particular content item, such as a video, document, or interactive screen.

The term “interaction information” refers to data indicating various types of interactive behavior of the learning subject, including, for example, scrolling, pausing, replaying, zooming, or other UI operations.

The term “understanding degree information” refers to information indicating an estimated level of understanding or mastery of one or more topics by the learning subject, derived from performance, behavior, or other signals.

The term “learning progress information” refers to information indicating a temporal or structural progression of the learning subject through an education plan, such as which items are completed, in progress, or not yet started.

The term “update prompt sentence” refers to a prompt sentence that is generated to request an update of existing education plan information or education content information by providing contextual information such as current plan status, performance, and emotional state to the generative information processing model.

The term “emotional state information” refers to information indicating an estimated emotional condition of the learning subject, such as confusion, frustration, boredom, or engagement, inferred from sensor data and other inputs.

The term “terminal device” refers to an information processing device used by the learning subject, such as a personal computer, tablet, smartphone, or head-mounted display, that presents content and transmits data to the server.

The term “imaging apparatus” refers to a hardware component, such as a camera, configured to capture image or video data representing the learning subject.

The term “sound acquisition apparatus” refers to a hardware component, such as a microphone, configured to capture audio data representing speech or other sounds produced by the learning subject.

The term “text input information” refers to text data input by the learning subject or another user through the terminal device, such as typed messages, answers, or comments.

The term “emotion analysis processing” refers to computational processing that estimates emotional state information from one or more input modalities, such as image information, sound information, or text input information, using at least an image processing algorithm or a sound analysis algorithm.

The term “image processing algorithm” refers to a computational procedure applied to image information to detect, extract, or analyze features such as faces, facial landmarks, or expressions.

The term “sound analysis algorithm” refers to a computational procedure applied to sound information to detect, extract, or analyze acoustic or linguistic features, such as tone, prosody, or recognized words.

The term “display screen” refers to a user interface screen that presents information to the learning subject, such as menus, dashboards, or text-based content.

The term “task presentation screen” refers to a user interface screen that presents specific learning tasks, questions, or activities to the learning subject.

The term “video playback screen” refers to a user interface screen that presents moving image content, such as lectures or demonstrations, for viewing by the learning subject.

The term “virtual space display screen” refers to a user interface screen that presents a two-dimensional or three-dimensional virtual environment, including augmented reality or virtual reality presentations, to the learning subject.

The term “control information” refers to information used by the terminal device to configure or render user interface screens, including layout parameters, content references, and interaction settings.

The term “predetermined condition” refers to a condition defined in advance, such as a threshold, rule, or pattern, used to determine whether an update prompt sentence should be generated or whether an education plan should be updated.

The term “threshold condition” refers to a type of predetermined condition in which one or more values, such as emotional state scores, understanding degree scores, or progress metrics, are compared against one or more threshold values.

The term “change condition” refers to a type of predetermined condition based on a change over time, such as a trend or fluctuation in emotional state information, understanding degree information, or learning progress information.

The term “explanatory content” refers to education content information that provides explanations, definitions, or descriptions of concepts to support understanding by the learning subject.

The term “practice tasks” refers to education content information that defines exercises or problems to be solved by the learning subject.

The term “presentation order” refers to information specifying a sequence or arrangement in which education content items or tasks are to be presented to the learning subject.

The term “difficulty level” refers to information indicating a relative degree of challenge of a content item or task, such as easy, intermediate, or advanced.

The term “motivational messages” refers to content elements generated to encourage, reassure, or otherwise motivate the learning subject during the learning process.

The term “dynamically update” refers to modifying education plan information or education content information during operation of the system, in response to current or recent data, without requiring manual reprogramming or restarting of the system.

In one embodiment, a server, a terminal, and a network collectively implement the system. The server includes at least one processor, a main memory, a non-volatile storage device, and a network interface. The terminal includes a processor, a display, an imaging apparatus such as a camera, a sound acquisition apparatus such as a microphone, input devices such as a keyboard or touch panel, and a communication interface. The server and the terminal are connected via a communication network such as the Internet or a local area network.

The server executes an operating system and application software implemented, for example, using a programming language such as Python. The server uses general-purpose software components such as a relational database management system (for example, a database engine of the MySQL type), a web application framework (for example, a framework of the Django type), and data analysis libraries (for example, a library of the pandas type and a library of the scikit-learn type). The server also executes numerical computation frameworks and machine learning frameworks (for example, frameworks of the TensorFlow type or PyTorch type) to implement machine learning processing and a generative AI model.

The server acquires learning history information and behavior history information of a learning subject from an information storage apparatus. The information storage apparatus stores records such as problem identifiers, correctness flags, response times, topic labels, timestamps, and content access logs as relational tables. The server loads these tables into in-memory data structures, such as data frames provided by a data analysis library, to perform data aggregation, normalization, and feature computation. The server generates feature vectors for each learning subject, the feature vectors including, for example, per-topic accuracy rates, average response times, variance of response times, content-type usage ratios, and counts of revisits to specific topics.

The server applies machine learning processing to the feature vectors by executing algorithms implemented in a machine learning library. In one example, the server uses a clustering algorithm of the K-means type to assign each learning subject to a cluster that represents a characteristic learning pattern. The server initializes cluster centroids, iteratively assigns feature vectors to nearest centroids according to a distance function such as Euclidean distance, and updates the centroids until convergence. The server thereby generates characteristic information that includes a cluster label and derived metrics such as “strong in algebra,” “weak in derivatives,” or “prefers video content.” The server stores the characteristic information as structured data, for example as records in a learner-profile table in the database.

The server also computes progress information and understanding degree information using stored learning history. The server aggregates completion counts, success rates, and elapsed times per plan item and per topic, and stores these as progress fields. The server can use regression or classification models implemented in a machine learning framework to estimate a probability of mastery per concept, which is represented as understanding degree information. For example, the server can use a logistic regression model or a shallow neural network to map input features such as accuracy, attempts, and time to a mastery probability.

The server stores these values in association with the characteristic information.

The server generates a prompt sentence in a natural language based on the characteristic information and the progress information. The server constructs the prompt sentence using a template-based mechanism. The server selects sentence templates that define clause structures such as “Learner has high performance in [topic A] and low performance in [topic B], and spends long time on [topic C].” The server inserts numeric or categorical values from the characteristic information and the progress information into these templates. For example, the server generates a prompt sentence such as:

“Learner X has high scores in limits, low scores in derivatives, and tends to spend a long time on calculus questions. Generate a one-week personalized study plan with explanations, practice problems, and short video recommendations to improve derivatives.” The server thereby uses the prompt sentence as a machine-readable control representation that encapsulates multiple computed features in a compressed natural-language form.

The server transmits the prompt sentence as an input to a generative AI model. In one embodiment, the generative AI model is implemented as a neural network of the transformer type executed on a machine learning framework. The generative AI model includes multiple layers of self-attention, feedforward sub-layers, and layer normalization. The model is trained in advance on a large corpus using a language modeling objective that minimizes a loss function such as cross-entropy between predicted tokens and ground-truth tokens. During inference, the server encodes the prompt sentence as a sequence of tokens, feeds the tokens into the generative AI model, and obtains a sequence of output tokens that represent an education plan description or education content description. The server specifies generation parameters such as maximum sequence length, temperature, and top-k or top-p sampling thresholds to control diversity and determinism of the output.

The server converts the generated output into education plan information and education content information. When the generative AI model outputs a structured representation (for example, headings such as “Day 1”, “Topic: Derivatives Basics”, “Tasks: . . . ”), the server parses the text, identifies segments corresponding to days, topics, tasks, and descriptions, and maps them to an internal schema. The internal schema may include fields such as plan identifier, day index, topic identifier, content type, difficulty level, and estimated duration.

The server stores these as structured data in the database. For education content information, the server extracts references to existing content items or descriptions of items that need to be generated. The server stores these as records in a content-definition table and associates them with content identifiers or external resource locations.

The server manages identifiers and reference information to link education plan information and education content information. For existing content, the server retrieves stored identifiers and uniform resource locators that reference video files, documents, or interactive exercises.

For content that does not yet exist, the server may invoke the generative AI model again with a more specific prompt sentence, such as:

“Generate 5 easy derivative practice problems for a high-school learner, each with a step-by-step solution.”

The server receives the problems and solutions, segments them into individual items, and stores them in a content repository with associated identifiers and metadata such as topic, difficulty level, and format. The server thereby improves data management by maintaining a consistent, machine-readable relationship between plan records and content records.

The terminal receives education plan information and education content information from the server. The terminal requests plan data via a network protocol such as HTTPS and receives responses in a structured format such as JavaScript Object Notation. The terminal parses the structured data, constructs user interface components such as lists of tasks, and displays education content using a browser engine or a native user interface toolkit. The terminal can open video content in a video player, display documents in a document viewer, or render three-dimensional content using a game engine of the Unity type. The terminal thus uses control information generated by the server to configure a display screen, a task presentation screen, a video playback screen, or a virtual space display screen.

The terminal acquires image information and sound information using the imaging apparatus and the sound acquisition apparatus. The terminal captures image frames of the learning subject's face and audio segments of the learning subject's speech. The terminal optionally performs pre-processing such as down-sampling, compression, or face-region cropping and transmits the processed data to the server. In an alternative embodiment, the terminal executes an on-device model of the lightweight type, such as a convolutional neural network implemented using a mobile-optimized framework, to compute provisional emotion labels and sends only the labels and confidence scores to the server. This variant reduces communication load and latency.

The server executes emotion analysis processing using the received image information, sound information, and text input information. The server applies an image processing algorithm implemented with a computer vision library such as OpenCV to detect faces and facial landmarks. The server normalizes the face regions and inputs them into an emotion classification model implemented as a neural network, such as a convolutional neural network with multiple convolutional layers, pooling layers, and fully connected layers. The emotion classification model outputs probability scores for a set of emotion classes, for example “confused,” “frustrated,” “bored,” and “engaged.” The server selects the emotion with the highest probability or computes a weighted combination for further processing.

The server transmits sound information to a speech recognition service and obtains a text transcription. The server applies a sound analysis algorithm and a text sentiment analysis algorithm, such as a recurrent neural network or transformer-based classifier, to detect negative or positive expressions and keywords such as “hard,” “don't understand,” or “easy.”

The server combines the results of face-based classification, speech-based analysis, and performance-based indicators such as repeated incorrect answers or very long response times.

The server uses a rule-based fusion mechanism or a small neural network to map these inputs to emotional state information. The server stores the emotional state information in association with the characteristic information, the understanding degree information, and the learning progress information.

The server generates an update prompt sentence when a predetermined condition is satisfied.

The predetermined condition may be defined using threshold conditions on emotional state scores, understanding degree values, or progress ratios, or change conditions such as sudden drops or spikes. For example, the server may determine that an update is required if a confusion probability exceeds a threshold while the accuracy for a topic remains below a threshold for a specified number of attempts. The server then constructs an update prompt sentence such as:

“Learner X is studying derivatives, has failed the last 5 derivative problems, and shows confusion and frustration. Modify the current study plan to add an easier explanation, simpler practice problems, and a short motivational message.”

The server provides the update prompt sentence as an input to the generative AI model. The generative AI model generates updated education plan information and updated education content information that may change explanatory content, practice tasks, presentation order, difficulty level, or motivational messages. The server integrates the updated information into the existing structured data. For example, the server can insert new plan items before existing items, replace overly difficult problems with easier ones, or add motivational text messages.

The server then transmits the updated education plan information and the updated education content information to the terminal.

The terminal receives the updated information and reconfigures user interface components accordingly. The terminal can insert new explanation sections, display hints before exercises, or show motivational messages such as “Let us review the basics step by step.” The terminal thereby presents content that is adapted to the current state of the learning subject.

The described configuration improves computer technology in several respects. The server treats prompt sentences as intermediate control representations that encode multi-dimensional learner state and plan context in a compact textual form. By generating and updating prompt sentences programmatically based on structured feature vectors and emotional state information, the server enables a dynamic interaction with the generative AI model that goes beyond simple human-authored queries. This approach allows the server to automatically transform numerical and categorical features into rich, context-aware inputs for the generative AI model without manual intervention, which reduces human workload and enables real-time adaptation.

The server also improves processing efficiency and data management. The server uses well-defined internal schemas for education plan information and education content information, and maintains consistent identifiers and references. This structure avoids repeated parsing of unstructured text at the terminal and enables fast lookups and incremental updates. The server can reuse previously generated content for similar learner profiles, thereby reducing redundant computations by the generative AI model and lowering processing load.

The use of machine learning processing for characteristic information generation and understanding degree estimation provides more accurate and fine-grained learner models than simple rule-based approaches. The clustering and classification models process large volumes of historical data and uncover patterns that may not be accessible to human instructors or simple heuristics. Because the server executes these models directly on structured feature vectors, the system can refine clusters and parameters as new data accumulate, improving prediction accuracy over time.

The emotion analysis pipeline improves technical performance by enabling targeted and timely interventions. The server uses a combination of image, audio, and text modalities, and employs specific neural network architectures and fusion logic to infer emotional state information. This processing yields high-resolution signals that are used to trigger plan updates only when necessary, reducing unnecessary communications and rendering changes.

By coupling these signals with threshold and change conditions, the system avoids oscillatory or unstable behavior, thereby improving user experience and system stability.

The generative AI model structures allow the server to derive new content and plans that would be impractical to author manually in real time. Because the prompt sentences are automatically constructed from structured data and emotional state information, the server can generate tailored content segments, such as explanations at different difficulty levels or alternative task sequences. The system does not merely automate human lesson design, but rather performs continuous optimization of content and control signals at a computational scale, using learning algorithms and structured intermediate representations that differ from typical human workflows.

In another embodiment, the server uses different types of generative AI models for different purposes. For example, the server may use a large transformer-based language model for macro-level plan generation and a smaller specialized model for micro-level problem generation. The server can also use a sequence-to-sequence model for converting structured state descriptors into compact prompt sentences. These architectural variations illustrate that the inventive concept is not limited to a specific brand of model, but to the structured interaction between the server, the prompt sentence generator, and the generative AI model.

In yet another embodiment, the system is configured for content domains other than mathematics, such as language learning, science, or professional training. The server then adjusts feature extraction functions, topic labels, and content repositories, but maintains the same overall architecture of profile analysis, prompt sentence generation, generative AI model invocation, structured plan storage, emotion-fused plan updating, and terminal control information generation.

The server may further optimize communication and computation by caching generative AI outputs associated with specific combinations of characteristic information patterns and emotional state conditions. When the server detects a similar state in a different learning subject, the server can reuse cached plan segments or content items instead of invoking the generative AI model again. This caching mechanism reduces latency and computational cost while maintaining personalization at an acceptable level, because cached items are indexed by fine-grained state descriptors rather than by coarse categories.

Through these configurations, the system does not simply automate human teaching procedures, but instead implements a set of interlocking technical mechanisms: structured feature extraction; machine-learning-based profiling; prompt-sentence-based control of a generative AI model; structured storage and dynamic updating of education plan and content information; multimodal emotion sensing and fusion; and terminal control information generation for various display modes. The combination of these mechanisms improves processing speed, accuracy of learner state estimation, flexibility of plan adaptation, and efficiency of network and computation usage, thereby providing a concrete improvement in the operation of computer-based education support systems.

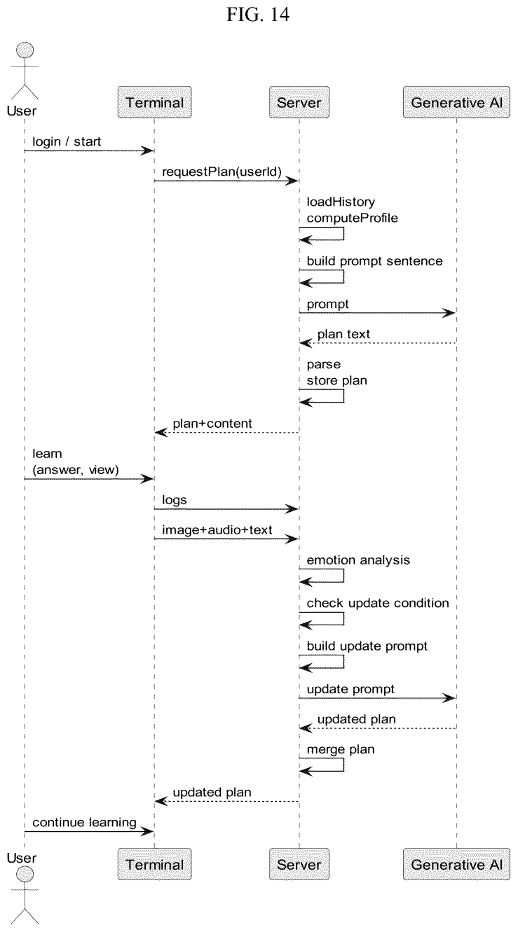

The following describes the processing flow using FIG. 14.

### Step 1:

Server acquires raw learner data.

Server receives as input a learner identifier from the terminal or from an internal scheduler.

Server, using the learner identifier, sends database queries to an information storage apparatus (for example, a relational database) to obtain learning history information and behavior history information.

Server reads tables such as problem attempts, test scores, content access logs, and timestamps, and loads them into in-memory data structures (for example, data frames).

Server outputs aggregated raw data sets per learner that contain rows with topic identifiers, correctness flags, response times, and content identifiers.

### Step 2:

Server computes feature vectors and characteristic information.

Server receives as input the aggregated raw data sets from Step 1.

Server performs data processing operations, including grouping by topic, computing per-topic accuracy, averaging response times, counting revisits, and estimating video versus text usage ratios.

Server normalizes numerical values (for example, scaling response times) and encodes categorical variables (for example, topic labels) into numeric form.

Server concatenates these processed values into feature vectors per learner and applies a machine learning algorithm (for example, clustering or classification) to derive characteristic information such as “strong topics,” “weak topics,” and “content format preference.” Server outputs a structured learner profile that includes feature vectors and characteristic information fields.

### Step 3:

Server calculates understanding degree information and learning progress information.

Server receives as input the learner profile from Step 2 and the learning history information from Step 1.

Server applies statistical computations and predictive models (for example, logistic regression or a small neural network) to map features such as accuracy, attempts, and elapsed time to a mastery probability per concept.

Server records which plan items are completed, in progress, or not started, and calculates progress ratios for each topic and each plan segment.

Server outputs understanding degree information (for example, mastery scores) and learning progress information (for example, completion percentages) associated with the learner identifier.

### Step 4:

Server constructs a prompt sentence for initial plan generation.

Server receives as input the characteristic information and the progress information from Step 3.

Server performs template-based natural language generation: it selects a sentence pattern and fills the pattern with topic names, performance descriptions, and progress metrics derived from the input.

Server, for example, inserts “high scores in limits” and “low scores in derivatives” into a generic sentence structure and appends a request clause.

Server outputs a prompt sentence such as:

“Learner X has high scores in limits, low scores in derivatives, and tends to spend a long time on calculus questions. Generate a one-week personalized study plan with explanations, practice problems, and short video recommendations to improve derivatives.”

### Step 5:

Server interacts with the generative AI model to obtain an initial plan.

Server receives as input the prompt sentence from Step 4.

Server tokenizes the prompt sentence into tokens and sends these tokens to a generative AI model (for example, a transformer-based language model) via an inference interface or external API.

Server controls generation parameters (for example, maximum token length, sampling strategy) and instructs the generative AI model to produce an output describing an education plan and associated content.

Server receives as output a generated text sequence that describes plan elements such as days, topics, tasks, and recommended content types.

### Step 6:

Server parses generated text into structured education plan information and education content information.

Server receives as input the generated text sequence from Step 5.

Server scans the text to detect structural markers (for example, “Day 1”, “Task:”, “Video:”), splits the text into segments, and maps each segment to internal fields such as day index, topic, content type, and description.

Server converts the parsed segments into structured records and associates them with a plan identifier and learner identifier.

Server outputs education plan information (for example, list of tasks with schedule and difficulty) and education content information (for example, content definitions and descriptions) in a structured format.

### Step 7:

Server resolves or generates concrete content items.

Server receives as input the education content information from Step 6.

Server queries a content repository using topic identifiers and content type labels to find matching existing items, such as video files, documents, or problem sets.

Server, for any missing content, generates an additional prompt sentence (for example, “Generate 5 easy derivative practice problems for a high-school learner, each with a step-by-step solution.”) and sends it to the generative AI model.

Server receives the generated content text, segments it into individual items, assigns content identifiers, and stores the items in the content repository.

Server outputs fully resolved content references for each plan item, including identifiers and access locations.

### Step 8:

Server stores plan and content structures and prepares control information.

Server receives as input the education plan information and resolved content references from Step 7.

Server performs database write operations to store plan records, link them to learner identifiers, and associate each plan element with one or more content identifiers.

Server generates control information that describes how each plan element should be presented on a terminal device, including screen type (task list, video player, quiz view), layout hints, and navigation rules.

Server outputs persistent plan data and control information ready to be transmitted to the terminal.

### Step 9:

Terminal requests and receives an education plan.

Terminal receives as input a user login event or an explicit user request to start or continue learning.

Terminal sends a network request to the server specifying the learner identifier and requesting current plan data.

Terminal receives as output a structured response containing education plan information, content references, and control information.

Terminal parses the response and stores the plan data temporarily in local memory.

### Step 10:

Terminal renders learning screens and logs user interactions.

Terminal receives as input the plan data and control information from Step 9.

Terminal configures a display screen, task presentation screen, video playback screen, or virtual space display screen according to the control information, including UI layout, buttons, and navigation elements.

Terminal loads referenced content items (for example, by downloading video streams or document files) and displays them to the user.

Terminal captures user operations such as button clicks, answer selections, page scrolls, video play/pause events, and time spent on each item.

Terminal outputs learning operation history information, answer result information, viewing time information, and interaction information, which it sends back to the server in periodic or event-driven batches.

### Step 11:

Terminal acquires multimodal emotion-related data.

Terminal receives as input a signal to start a learning session or to monitor emotional state during learning.

Terminal activates the imaging apparatus and the sound acquisition apparatus to capture image frames of the user's face and audio segments of the user's speech.

Terminal optionally pre-processes the captured data by resizing images, compressing video frames, normalizing audio loudness, or extracting face regions.

Terminal outputs image information and sound information, and may also capture text input information typed by the user, and transmits these data sets to the server as emotion analysis inputs.

### Step 12:

Server performs emotion analysis and updates emotional state information.

Server receives as input image information, sound information, and text input information from Step 11.

Server applies an image processing algorithm to detect faces and facial landmarks in each frame, crops and normalizes face regions, and feeds the resulting images into an emotion classification neural network to compute probabilities for emotions such as confusion or frustration.

Server sends audio to a speech recognition component to obtain a text transcript, then applies a text classification or sentiment analysis model to identify phrases indicating difficulty or satisfaction.

Server combines face-based emotion probabilities, speech-based sentiment results, and recent performance metrics (for example, sequence of wrong answers) by applying a fusion rule or a small neural network.

Server outputs emotional state information representing the current emotional condition of the learner and stores it in association with the learner profile.

### Step 13:

Server monitors understanding, progress, and emotion, and checks update conditions.

Server receives as input the understanding degree information and learning progress information from Step 3 and the emotional state information from Step 12, as well as new interaction logs from Step 10.

Server periodically or upon specific events updates its estimates of understanding degree and progress by recomputing statistics and, if necessary, re-running prediction models on the extended data.

Server evaluates predetermined conditions (for example, threshold conditions on confusion probability and low accuracy in a topic, or change conditions reflecting sudden drops in engagement) using logical rules.

Server outputs a decision flag indicating whether the current plan should remain unchanged or an update should be triggered, and identifies which topics or tasks require modification.

### Step 14:

Server generates an update prompt sentence for plan adjustment.

Server receives as input the decision flag and the learner state data (understanding degree, progress, emotional state, and current plan segment) from Step 13.

Server constructs an update prompt sentence by combining descriptive phrases about the learner's difficulties and emotions with instructions to modify specific types of content.

Server, for example, generates a prompt sentence such as:

“Learner X is studying derivatives, has failed the last 5 derivative problems, and shows confusion and frustration. Modify the current study plan to add an easier explanation, simpler practice problems, and a short motivational message.”

Server outputs the update prompt sentence for use by the generative AI model.

### Step 15:

Server obtains updated education plan information and content via the generative AI model.

Server receives as input the update prompt sentence from Step 14.

Server submits the prompt sentence to the generative AI model and requests an updated plan segment that includes revised explanations, problem sets, presentation order, difficulty levels, or motivational messages.

Server receives as output a text description of the updated plan and content.

Server parses the text into structured updated education plan information and updated education content information, following similar parsing rules as in Step 6.

### Step 16:

Server merges updated plan with existing structures and prepares incremental control updates.

Server receives as input the updated education plan information and updated education content information from Step 15 and the existing plan data from Step 8.

Server identifies plan items to be inserted, replaced, or removed by comparing identifiers, topics, and positions in the current sequence.

Server modifies the plan records accordingly, marks obsolete entries, and updates references to new or changed content items.

Server generates incremental control information that specifies which parts of the user interface should be refreshed or reconfigured on the terminal.

Server outputs the revised plan and incremental control instructions for the terminal.

### Step 17:

Terminal receives and applies plan updates during an ongoing session.

Terminal receives as input the revised plan and incremental control instructions from Step 16.

Terminal analyzes which tasks or content blocks in the currently displayed screens need to be altered, and updates UI components accordingly, for example by inserting a new “basic explanation” block or replacing a difficult quiz with an easier one.

Terminal displays any newly generated motivational messages or guidance text to the user.

Terminal continues to log user interactions and emotional data according to Steps 10 and 11, thereby closing the feedback loop and providing further input to the server for future updates.

### Step 18:

User interacts with the system and optionally provides explicit prompt sentences.

User receives as input the learning content and guidance displayed by the terminal.

User performs actions such as answering questions, watching videos, or typing free-form text messages (for example, questions or comments) into an input field.

User, in some cases such as a teacher or administrator, may explicitly enter a prompt sentence like:

“Generate a three-day algebra review plan for Student B, focusing on linear equations and factoring, and consider that Student B feels anxious about math tests.”

Terminal transmits this explicit prompt sentence and associated learner identifier to the server.

Server incorporates the explicit prompt into the same processing pipeline as internal prompt sentences, generating or updating plans via the generative AI model and returning results to the terminal, thus integrating user-driven and system-driven plan generation.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

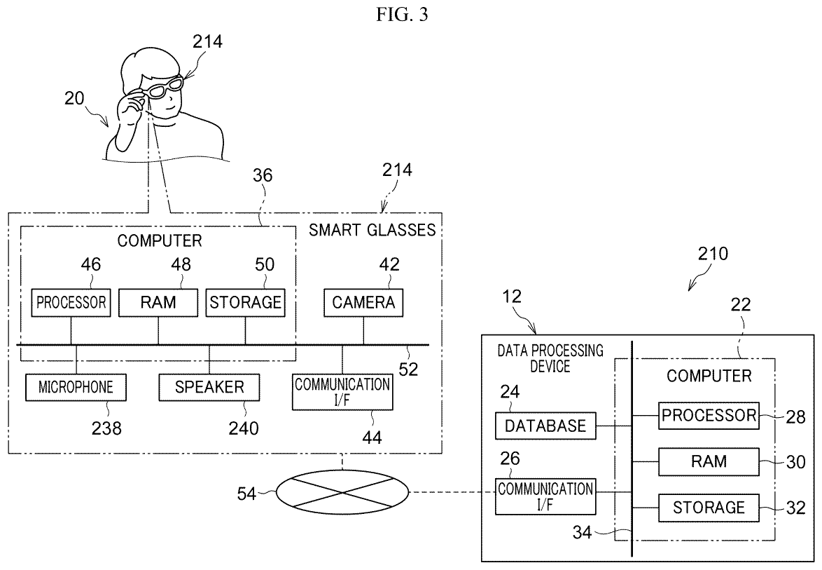

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

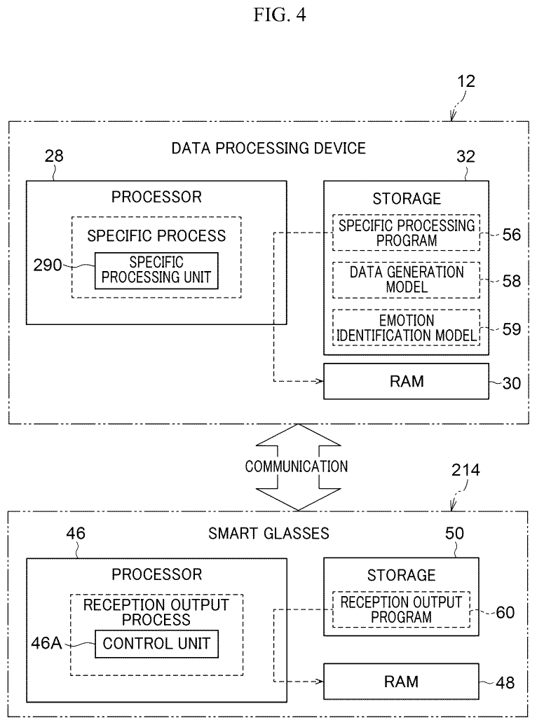

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

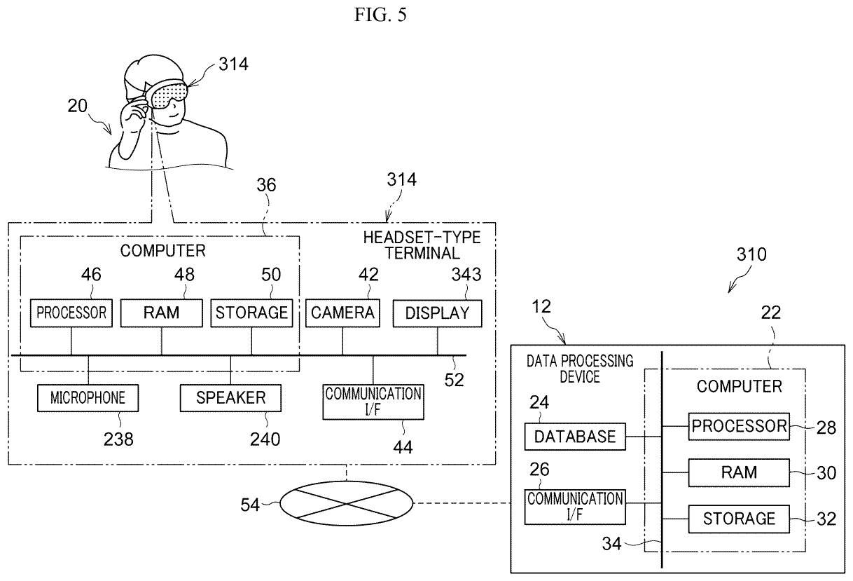

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

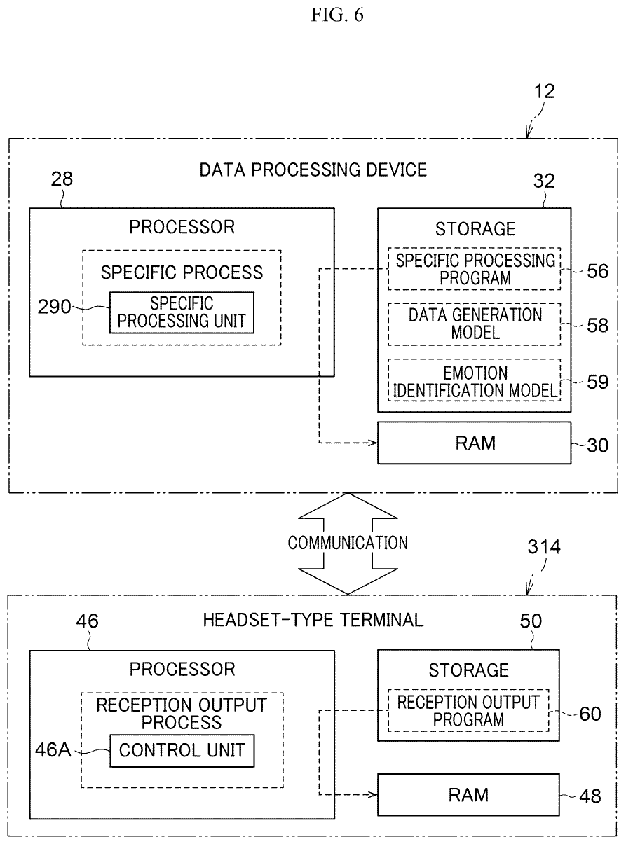

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

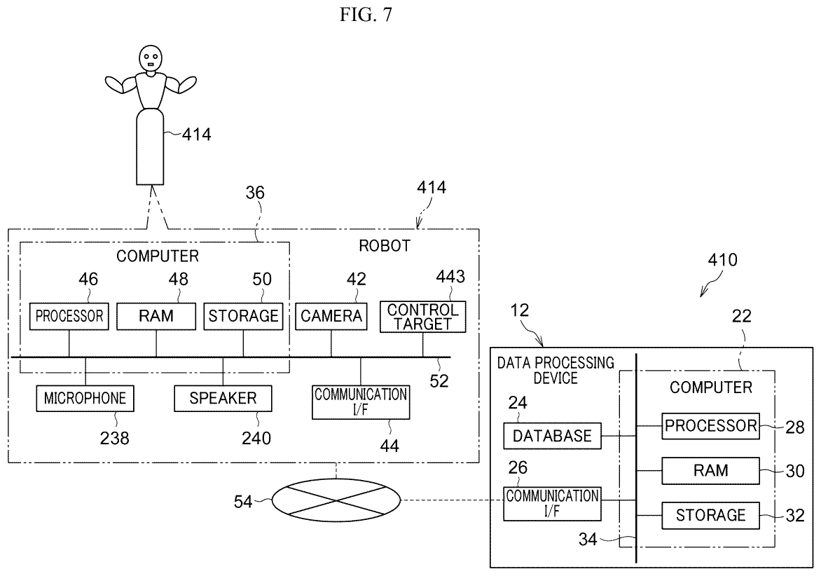

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

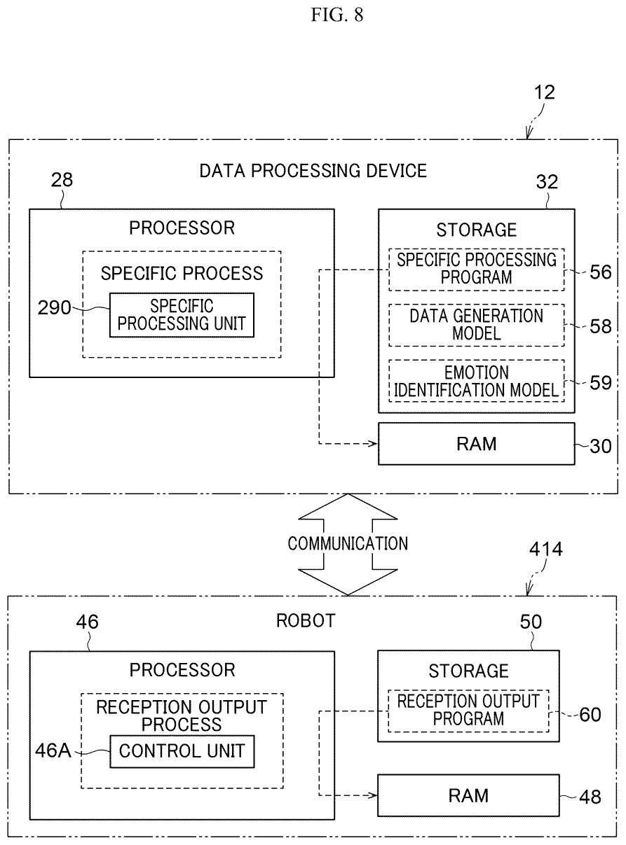

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

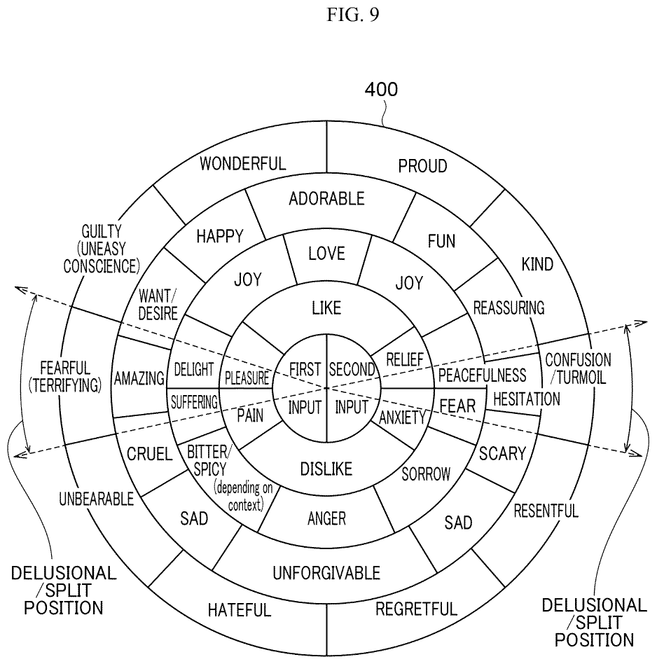

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

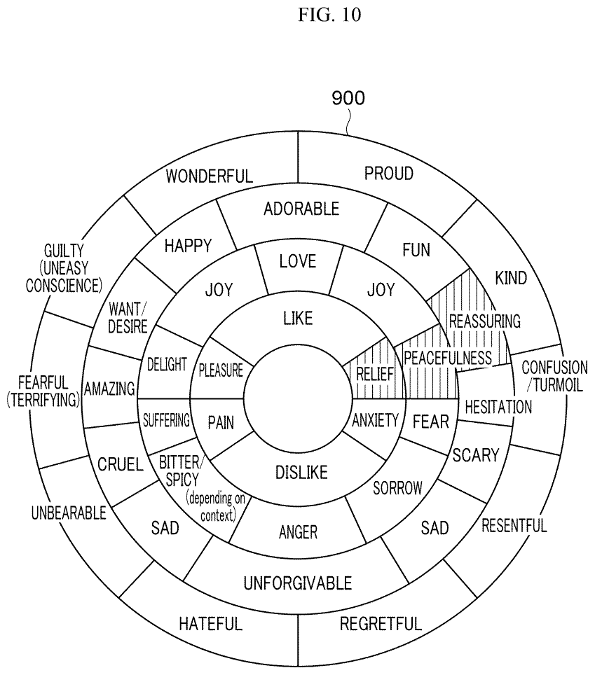

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor and a storage device,
wherein the processor is configured to
acquire learning activity information and behavior tendency information for each learner from a plurality of information processing terminals, and manage the acquired learning activity information and behavior tendency information as integrated learning history information stored in the storage device,
compute performance indices including at least a learning field, a learning subject, an answer history, an answer time, a correctness rate, a learning time, and a support request frequency based on the learning history information, and evaluate a comprehension level, a learning progress, and a learning characteristic of the learner by executing statistical processing and machine learning processing using the performance indices,
generate a prompt sentence in a natural language that describes creation conditions and constraint conditions of an education plan based on an evaluation result and the performance indices, input the prompt sentence to a generative artificial intelligence model, and obtain, from the generative artificial intelligence model, an individualized education plan candidate including at least a time allocation, a learning activity type, and a question configuration, analyze the education plan candidate, convert the education plan candidate into education plan data in a machine-readable format including elements of a learning unit, a learning procedure, a learning time, and a problem identifier, store the education plan data in the storage device, and transmit the education plan data to the information processing terminals, present learning tasks to the learner via the information processing terminals based on the education plan data, and acquire, via the information processing terminals, response information including at least an answer content, an answer time, an operation history, and a support request history with respect to the learning tasks, thereby generating new learning history information and additionally storing the new learning history information in the storage device, and
recalculate the performance indices and the evaluation result based on updated learning history information including the new learning history information, dynamically update the prompt sentence to be input to the generative artificial intelligence model according to a recalculation result, sequentially update the education plan candidate obtained from the generative artificial intelligence model, and adaptively change the education plan for each learner over time.

### (Supplementary 2)

The system according to supplementary 1,
wherein the processor is configured to
treat, as at least a part of the learning activity information and the behavior tendency information, emotion state information based on expression information, voice information, and character information acquired from a sensor device or an input/output device, perform emotion analysis processing using the emotion state information as an input when computing the performance indices and the evaluation result, and change contents of the prompt sentence to be input to the generative artificial intelligence model according to the emotion state information.

### (Supplementary 3)

The system according to supplementary 1,
wherein the processor is configured to
cause the prompt sentence to include indices relating to the comprehension level, the learning progress, the learning characteristic, and the emotion state of the learner, and constraint conditions relating to the learning time, the learning activity type, a question difficulty, and a support presentation policy, and, in response to an update of the prompt sentence,
automatically reconfigure, in the education plan data, at least an allocation ratio among review activities, practice activities, and evaluation activities, a question order, and a support presentation frequency.

### Application Example 1

### (Supplementary 1)

A system comprising a processor,
wherein the processor is configured to
acquire, from an information terminal operated by a learner, behavior information including a learning history and a behavior pattern related to learning tasks, the behavior information including at least a response result to a learning task, a time required for the response, a browsing history of presented materials, and a reference history of support information, and store the behavior information in a storage device,
execute, on the basis of the behavior information stored in the storage device, a statistical learning process by using an information processing program for machine learning, and calculate learner characteristic information representing, for each learner, at least a degree of understanding, a degree of acquisition, and a learning tendency,
select, on the basis of the learner characteristic information and attribute information of educational materials, a plurality of educational materials, and generate education plan data including at least a learning order and a learning time allocation,
generate, by using the education plan data, the learner characteristic information, and condition information including a candidate set of the educational materials, an instruction sentence in a natural language, and construct a prompt sentence including the instruction sentence as an input to a generative information processing model,
input the prompt sentence to the generative information processing model, obtain, from the generative information processing model, educational content control information including at least explanatory information corresponding to the education plan data, learning procedures, and details of learning contents, and store the educational content control information in the storage device in association with the education plan data,
acquire, while the learner executes the educational materials via the information terminal, progress information sequentially transmitted from the information terminal, the progress information including at least a response status, an operation history, and a support request, and monitor, in real time, the degree of understanding and a learning progress of the learner while temporally updating the degree of understanding and the learning progress on the basis of the progress information, and
when an update result of the degree of understanding and the learning progress satisfies a predetermined condition, dynamically update the education plan data by changing a selection and a presentation order of the educational materials included in the education plan data and/or by adding a new educational material, regenerate the prompt sentence on the basis of the updated education plan data, re-input the regenerated prompt sentence to the generative information processing model, obtain, in real time, adaptive educational content control information from the generative information processing model, and transmit the adaptive educational content control information to the information terminal.

### (Supplementary 2)

The system according to supplementary 1,
wherein the processor is configured to execute an emotion estimation process by using image data, acoustic data, and character string data acquired from the information terminal or an external input device, the emotion estimation process including at least a facial expression recognition process, a voice feature analysis process, and a context analysis process, calculate emotion information representing an emotional state of the learner, and add the emotion information, as a part of the learner characteristic information, to the prompt sentence.

### (Supplementary 3)

The system according to supplementary 1,
wherein the processor is configured to, when the emotion information satisfies a predetermined threshold condition, include, in the prompt sentence, additional conditions for modifying at least one of the education plan data and the educational content control information in accordance with the emotion information, input the prompt sentence including the additional conditions to the generative information processing model, obtain, from the generative information processing model, updated educational content control information including at least a selection of educational materials, a presentation order of the educational materials, an expression of explanatory sentences, and support messages adjusted in accordance with the emotional state of the learner, and dynamically update the education plan data on the basis of the updated educational content control information.

### Example 2

### (Supplementary 1)

A system comprising a processor and a storage device,
wherein the processor is configured to
acquire learning record information and behavior history information of a learning subject from the storage device, and calculate, by numerical computation processing and information aggregation processing, a comprehension index and a progress index for each learning task; and
generate, on the basis of the comprehension index and the progress index, a summary sentence describing characteristics and a learning state of the learning subject, generate generation instruction information for a generative artificial intelligence model by forming the summary sentence as a prompt sentence to be input to the generative artificial intelligence model, and input the prompt sentence to the generative artificial intelligence model; and
extract, on the basis of natural language text output from the generative artificial intelligence model, education plan information as structured data including items relating to learning tasks, learning order, learning materials, and difficulty level, and generate an individualized education plan for each learning subject by using the structured data; and
receive learning result information and feedback information from a terminal device,
recalculate the comprehension index and the progress index to reflect the learning result information and the feedback information, compare the recalculated comprehension index and the recalculated progress index with threshold information, and determine whether to advance to a next learning task or to repeat a same learning task; and
update the education plan dynamically by, in accordance with a determination result, reflecting in the generation instruction information a first prompt sentence for the generative artificial intelligence model that causes the individualized education plan to include a new learning domain for a learning task permitted to advance, and reflecting in the generation instruction information a second prompt sentence for the generative artificial intelligence model that causes the individualized education plan to include additional problem information and explanation information for a learning task requiring relearning, and regenerating the education plan by using outputs from the generative artificial intelligence model; and
transmit updated education plan information to the terminal device via a communication line, and cause the terminal device to display the education plan information.

### (Supplementary 2)

The system according to supplementary 1,
wherein the processor is configured to
acquire, from the terminal device, the learning result information and the feedback information as answer history information, learning time information, operation history information, and subjective evaluation information, and embed text information including the subjective evaluation information into the prompt sentence so as to provide the generative artificial intelligence model with constraint conditions for modification of the education plan.

### (Supplementary 3)

The system according to supplementary 1,
wherein the processor is configured to
determine whether the natural language text obtained from the generative artificial intelligence model conforms to a predetermined format or data structure, automatically generate an additional prompt sentence requesting format correction or structured output and re-input the additional prompt sentence to the generative artificial intelligence model when the natural language text does not conform to the predetermined format or the data structure, and manage versions of the education plan information for each learning subject on the basis of output after the format correction.

### Application Example 2

### (Supplementary 1)

A system comprising a processor,
wherein the processor is configured to
acquire learning history information and behavior history information of a learning subject from an information storage apparatus, and analyze the learning history information and the behavior history information by machine learning processing to generate characteristic information of the learning subject,
generate, on the basis of the characteristic information and progress information of the learning subject, a prompt sentence in a natural language including the characteristic information and the progress information, and transmit the prompt sentence as an input to a generative information processing model so as to cause the generative information processing model to generate at least one of individualized education plan information and education content information,
store the education plan information and the education content information output from the generative information processing model as structured data, and manage identifiers, reference information, or generated content of educational content in association with the structured data,
acquire, in real time or at predetermined time intervals, learning operation history information, answer result information, viewing time information, and interaction information of the learning subject transmitted from a terminal device, and monitor understanding degree information and learning progress information of the learning subject by evaluating an achievement status with respect to the education plan information,
generate, in addition to the understanding degree information and the learning progress information, an update prompt sentence in a natural language for updating at least a part of the education plan information when at least a predetermined condition is satisfied, and re-input the update prompt sentence to the generative information processing model so as to cause the generative information processing model to dynamically generate updated education plan information and updated education content information, and transmit the updated education plan information and the updated education content information to the terminal device, and
generate control information for configuring at least one of a display screen, a task presentation screen, a video playback screen, and a virtual space display screen in the terminal device on the basis of the education plan information and the education content information, and provide the control information to the terminal device.

### (Supplementary 2)

The system according to supplementary 1,
wherein the processor is configured to
estimate emotional state information of the learning subject on the basis of image information and sound information acquired from an imaging apparatus and a sound acquisition apparatus provided in the terminal device, and text input information transmitted from the terminal device, by emotion analysis processing including an image processing algorithm and a sound analysis algorithm, store the emotional state information in association with the characteristic information, the understanding degree information, and the learning progress information, and generate a prompt sentence including the emotional state information and input the prompt sentence to the generative information processing model.

### (Supplementary 3)

The system according to supplementary 1,
wherein the processor is configured to
when at least a part of the emotional state information, the understanding degree information, and the learning progress information satisfies a predetermined threshold condition or change condition, generate an update prompt sentence including current education plan information, current education content information, the emotional state information, the understanding degree information, and the learning progress information, input the update prompt sentence to the generative information processing model, obtain updated education plan information and updated education content information including at least one of explanatory content, practice tasks, presentation order, difficulty level, and motivational messages, and
dynamically update the education plan information on the basis of the updated education plan information and the updated education content information.

What is claimed is:

1. A system comprising:
a communication interface coupled to a packet-switched network; and
circuitry configured to:
acquire, from a storage device, activity history data and behavior pattern data associated with a user identifier;
compute performance indices from the activity history data comprising at least an interaction frequency, a response time metric, and an accuracy rate;
execute a machine learning algorithm on the performance indices to generate an evaluation result representing a comprehension level and a progress state of the user;
generate a prompt sentence based on the evaluation result and the performance indices, the prompt sentence being configured to instruct a generative neural network model to generate structured content data;
input the prompt sentence to the generative neural network model and obtain, from the generative neural network model, content candidate data comprising at least a sequence of content units and associated configuration parameters; and
transmit the content candidate data to a terminal device via the communication interface.

2. The system according to claim 1, wherein the circuitry is configured to monitor, in real time, interaction data received from the terminal device via the communication interface, compare the interaction data with the evaluation result, and dynamically update the prompt sentence when a detected change in the comprehension level exceeds a predetermined threshold.

3. The system according to claim 2, wherein the circuitry is configured to convert the content candidate data into a machine-readable format comprising elements of a content unit identifier, a sequence order, a time allocation, an activity type, and a difficulty parameter, and store the converted data in the storage device.

4. The system according to claim 3, wherein the circuitry is configured to detect, from the interaction data, that the accuracy rate for a particular content unit falls below a threshold, and generate a supplementary prompt sentence instructing the generative neural network model to produce alternative content data for the particular content unit.

5. The system according to claim 4, wherein the prompt sentence comprises a structured template including a target concept field, a difficulty level field, a preferred explanation style field, and an output format constraint field populated with values derived from the evaluation result.

6. The system according to claim 5, wherein the circuitry is configured to apply a reinforcement signal to update generation parameters of the prompt sentence based on a comparison between predicted comprehension improvement and actual comprehension improvement measured from subsequent interaction data.

7. The system according to claim 1, wherein the circuitry is configured to acquire, via the communication interface, multimodal input data from the terminal device comprising at least one of image data representing a facial expression, audio feature data, and text input data, and recognize an emotional state of the user by executing an emotion analysis algorithm on the multimodal input data.

8. The system according to claim 7, wherein the circuitry is configured to incorporate the emotional state into the prompt sentence such that the generative neural network model adjusts at least one of a complexity level, a presentation style, and a pacing parameter of the content candidate data based on the emotional state.

9. The system according to claim 8, wherein the generative neural network model comprises a transformer architecture having a plurality of self-attention layers, and the circuitry is configured to set inference parameters comprising at least a temperature value and a maximum output token count prior to inputting the prompt sentence.

10. The system according to claim 9, wherein the circuitry is configured to maintain an interaction history in the storage device comprising a sequence of prior prompt sentences, corresponding content candidate data, and user response data, and incorporate at least a portion of the interaction history into a subsequent prompt sentence.

11. The system according to claim 1, wherein the machine learning algorithm comprises at least one of: a classification algorithm for categorizing the user into a proficiency level, a regression algorithm for predicting a performance trajectory, and a clustering algorithm for grouping behavior patterns into interaction style categories.

12. The system according to claim 11, wherein the circuitry is configured to compute a knowledge state vector representing estimated proficiency values across a plurality of content domains, and update the knowledge state vector after each interaction session based on observed response patterns.

13. The system according to claim 12, wherein the circuitry is configured to detect an anomaly in the content candidate data by computing a deviation metric between expected output parameters derived from the evaluation result and actual parameters of the content candidate data, and trigger regeneration when the deviation metric exceeds a threshold value.

14. The system according to claim 13, wherein the regeneration comprises modifying the prompt sentence to include an indication of the detected deviation and retransmitting the modified prompt sentence to the generative neural network model.

15. The system according to claim 1, wherein the circuitry is configured to execute a natural language processing operation on free-form text input received from the terminal device to extract intent information and topic information, and integrate the extracted information with the performance indices for generating the prompt sentence.

16. The system according to claim 1, wherein the circuitry is configured to generate a plurality of content candidate variants by transmitting a plurality of prompt sentence variants to the generative neural network model, score each variant based on predicted engagement using a scoring model, and select a highest-scoring variant for transmission to the terminal device.

17. The system according to claim 1, wherein the behavior pattern data comprises at least one of: temporal activity distribution data indicating times of interaction, session duration data, error pattern data indicating frequently confused content categories, and support request frequency data.

18. A system comprising:
a communication interface coupled to a packet-switched network; and
circuitry configured to:
acquire, from a storage device, activity history data and behavior pattern data associated with a user identifier;
compute performance indices and execute a machine learning algorithm to generate an evaluation result comprising a comprehension level, a progress state, and a proficiency classification;
acquire multimodal input data via the communication interface and recognize an emotional state of the user by executing an emotion analysis algorithm;
generate a prompt sentence based on the evaluation result, the performance indices, and the emotional state, the prompt sentence comprising a structured template with a target concept field, a difficulty level field, and an output format constraint field;
input the prompt sentence to a generative neural network model comprising a transformer architecture and obtain content candidate data;
monitor real-time interaction data from the terminal device and dynamically update the prompt sentence when a change in the comprehension level or the emotional state exceeds a threshold;
detect an anomaly in the content candidate data by computing a deviation metric and trigger regeneration when the deviation metric exceeds a threshold value; and
transmit verified content candidate data to the terminal device via the communication interface.

19. The system according to claim 18, wherein the circuitry is configured to train the machine learning algorithm using a training dataset comprising historical activity records paired with proficiency labels, the training applying a loss function and updating model parameters using a gradient-based optimization algorithm.

20. A method comprising:
acquiring, from a storage device, activity history data and behavior pattern data associated with a user identifier;
computing performance indices from the activity history data comprising at least an interaction frequency, a response time metric, and an accuracy rate;
executing a machine learning algorithm on the performance indices to generate an evaluation result representing a comprehension level and a progress state of a user;
generating a prompt sentence based on the evaluation result and the performance indices, the prompt sentence being configured to instruct a generative neural network model to generate structured content data;
inputting the prompt sentence to the generative neural network model and obtaining, from the generative neural network model, content candidate data comprising at least a sequence of content units and associated configuration parameters; and
transmitting the content candidate data to a terminal device via a communication interface coupled to a packet-switched network.
